(19) United States
(12) Patent Application Publication
(10) Pub. No.: US 2012/0299470 A1
(43) Pub. Date: Nov. 29, 2012

(54) ILLUMINATION DEVICE HAVING MULTIPLE LIGHT EMITTING PANELS

(75) Inventors: Yuhki Kobayashi, Osaka (JP); Yoshimasa Fujita, Osaka (JP)

(73) Assignee: Sharp Kabushiki Kaisha, Osaka (JP)

(21) Appl. No.: 13/519,882

(22) PCT Filed: Nov. 2, 2010
(86) PCT No.: PCT/JP2010/069474

§ 371 Date: Jun. 28, 2012

(30) Foreign Application Priority Data
Jan. 7, 2010 (JP) 2010-002353
Apr. 26, 2010 (JP) 2010-101231

(51) Int. Cl. H05B 33/02; H05B 33/14

(52) U.S. Cl. 313/504; 313/511

(57) ABSTRACT

An illumination device (1) of the present invention includes slats (2) each having flexibility and being such that an organic layer (30) is provided between a first electrode (20) and a second electrode (21), the slats (2) being in parallel with other and movable rotatably forward and backward. The illumination device includes a support wire (4) for supporting the slats (2) so that the slats (2) are movable rotatably forward and backward, a power supply device (7) for supplying a voltage, via a conductive wire group (3), to the electrodes (20) and (21), and a slat pressure member (5) provided in the vicinity of one of surfaces of each slat (2), the slat pressure member giving pressure to each slat (2) from a position in the vicinity of the one of surfaces in accordance with rotational movement forward and backward of the slat (2) caused by the wire (4).

### TECHNICAL FIELD

The present invention relates to an illumination device in which a large light-emitting surface is realized by arranging a plurality of light-emitting panels each having a light-emitting section.

### BACKGROUND ART

An EL (electro luminescence) illumination device has attracted attention as a next-generation illumination device. A high cost and a large body have been largest problems of the EL illumination device. As a technique for solving both the problems, there has been proposed a blind-type (referred to as “screen-type” in some cases) illumination device which hangs on a window and adjusts an amount of daylighting. A “blind” is constituted by a large number of slats which are movable rotationally forward and backward, and are arranged in parallel with each other. Generally, a user adjusts an angle at which the slat is moved rotationally, so as to adjust the amount of the daylighting. In a case where the slat is moved to be parallel to a vertical direction (that is, in a case where the slat is moved so that a surface of the slat is parallel to the window), light entering the window is blocked by the blind. Otherwise, the light is let in via the window.

An example of a blind-type illumination device is described in Patent Literature 1. FIG. 23 is a perspective view illustrating a main part of an arrangement of the blind device. A blind device 100 is a horizontal blind in which a large number of slats 102 are arranged in parallel with each other in a horizontal direction (see FIG. 23). Both ends of each of the plurality of slats 102 are bound to a roll-up code (not illustrated). Each of the plurality of slats 102 is movable rotationally forward and backward. The plurality of slats can be rolled up, if necessary.

Each of the plurality of slats 102 has a three-layer structure in which (i) a solar cell 103 for converting solar energy into electrical energy, (ii) a sheet polymer secondary cell 104 for storing the electrical energy obtained through conversion by the solar cell 103, and (iii) a sheet surface-emitting member 105 for emitting light by application of a voltage supplied from the sheet polymer secondary cell 104 are stacked with each other in this order.

The solar cell 103 includes a terminal which (i) converts optical energy directly into electrical energy, and (ii) causes the sheet polymer secondary cell 104 to store the electrical energy thus converted.

The sheet polymer secondary cell 104 has a solid electrolyte made of a solid polymer. The sheet polymer secondary cell 104 includes a terminal which (i) stores the electrical energy obtained through conversion by the solar cell 103 and (ii) supplies the electrical energy thus stored to the sheet surface-emitting member 105.

The sheet surface-emitting member 105 may be an organic EL element which employs an organic thin film as an electroluminescence layer, for example. The sheet surface-emitting member 105 includes a terminal for receiving a voltage. The sheet surface-emitting member 105 emits light by receiving the electrical energy thus stored from the sheet polymer secondary cell 104.

Further, an electrical wire 106 for transmitting a signal for controlling light-emitting of the sheet surface-emitting member 105 is extended from each of the plurality of slats 102. Each of such electrical wires 106 is connected to a switch 107.

Such a blind device 100 is installed in the vicinity of a window in a room, so that the solar cell 103 of each of the plurality of slats 102 is provided in such a direction that the solar cell 103 can receive sunlight. The solar energy of the sunlight thus received is converted into electrical energy, and the electrical energy is stored in the sheet polymer secondary cell 104. Then, a voltage is supplied from the sheet polymer secondary cell 104 to the sheet surface-emitting member 105. The blind device 100 thus emits light.

### CITATION LIST

### Patent Literature

Patent Literature 1
Japanese Patent Application Publication, Tokukai, No. 2001-82058 A (Publication Date: Mar. 27, 2001)

### SUMMARY OF INVENTION

### Technical Problem

However, in the case of the blind device of Patent Literature 1, it is impossible to cause a shape of each of the plurality of slats to have a desired curvature radius reversibly. It is therefore impossible to control the light to be diffused or condensed. That is, this blind device is insufficient in illumination function.

### Solution to Problem

The present invention is made in view of the problems. An object of the present invention is to provide a blind-type illumination device which (i) can control light to be diffused or condensed, and (ii) can meet any lighting purposes.

That is, in order to attain the object, an illumination device of the present invention includes: a plurality of slats each having flexibility, each of the plurality of slats having a light-emitting element which emits light by supply of a current to the light-emitting element or application of a voltage to the light-emitting element, the light-emitting element including a first electrode and a second electrode; a support section for supporting the plurality of slats so that the plurality of slats are movable rotatably forward and backward, the support section including (i) a plurality of first support members provided for the plurality of slats, respectively, each of the plurality of first support members extending across one of surfaces of a corresponding one of the plurality of slats, and (ii) a second support member which is connected to the plurality of first support members so that the plurality of slats are arranged in parallel with each other; and a plurality of structures provided for the plurality of slats, respectively, each of the plurality of structures (i) being provided in the vicinity of the one of surfaces of the corresponding one of the plurality of slats, and (ii) giving, in accordance with rotational movement of the corresponding one of the plurality of slats, caused by the support section, pressure to the corresponding one of the plurality of slats from a position in the vicinity of the one of surfaces toward the other one of surfaces.

According to the arrangement, the illumination device includes the plurality of structures each (i) being provided in the vicinity of the one of surfaces of the corresponding one of the plurality of slats, and (ii) giving, in accordance with rotational movement of the corresponding one of the plurality of slats caused by the support section, pressure to the corresponding one of the plurality of slats from a position in the vicinity of the one of surfaces toward the other one of surfaces. The plurality of structures make it possible for the plurality of slats each having flexibility to be bent in accordance with the rotational movement. That is, it is possible to cause a shape of each of the plurality of slats to have a desired curvature radius reversibly.

As described above, by causing the slat to have a desired curvature radius reversibly, it becomes possible to cause the light emitted from the light-emitting element of the slat to be diffused or condensed. Accordingly, it is possible to provide an illumination device which can meet any lighting purposes.

Additional objects, features, and strengths of the present invention will be made clear by the description below. Further, the advantages of the present invention will be evident from the following explanation in reference to the drawings.

### Advantageous Effects of Invention

As described above, an illumination device of the present invention an illumination device of the present invention includes: a plurality of slats each having flexibility, each of the plurality of slats having a light-emitting element which emits light by supply of a current to the light-emitting element or application of a voltage to the light-emitting element, the light-emitting element including a first electrode and a second electrode; a support section for supporting the plurality of slats so that the plurality of slats are movable rotatably forward and backward, the support section including (i) a plurality of first support members provided for the plurality of slats, respectively, each of the plurality of first support members extending across one of surfaces of a corresponding one of the plurality of slats, and (ii) a second support member which is connected to the plurality of first support members so that the plurality of slats are arranged in parallel with each other; and a plurality of structures provided for the plurality of slats, respectively, each of the plurality of structures (i) being provided in the vicinity of the one of surfaces of the corresponding one of the plurality of slats, and (ii) giving, in accordance with rotational movement of the corresponding one of the plurality of slats, caused by the support section, pressure to the corresponding one of the plurality of slats from a position in the vicinity of the one of surfaces toward the other one of surfaces.

Accordingly, it is possible to provide a blind-type illumination device which can meet any lighting purposes by causing a shape of a slat to have a desired curvature radius reversibly.

### BRIEF DESCRIPTION OF DRAWINGS

FIG. 1 is a perspective view illustrating an arrangement of an illumination device in accordance with one embodiment of the present invention.

FIG. 2 is a cross-sectional view illustrating a slat provided in the illumination device illustrated in FIG. 1.

FIG. 3 is a cross-sectional view illustrating details of the slat provided in the illumination device illustrated in FIG. 1.

FIG. 4 is a top view illustrating the slat provided in the illumination device illustrated in FIG. 1.

FIG. 5 is a cross-sectional view illustrating details of the slat provided in the illumination device illustrated in FIG. 1.

FIG. 6 is a cross-sectional view illustrating a comparative arrangement in which no edge cover is provided.

FIG. 7 is a cross-sectional view illustrating the illumination device illustrated in FIG. 1.

FIG. 8 is a cross-sectional view illustrating the illumination device illustrated in FIG. 1.

FIG. 9 is a view illustrating how a shape of the slat provided in the illumination device illustrated in FIG. 1 is changed.

FIG. 10 is a view illustrating how a large light-emitting surface is realized by use of the illumination device illustrated in FIG. 1: (a) of FIG. 10 is a side view; and (b) of FIG. 10 is a front view.

FIG. 11 is a perspective view illustrating an arrangement of a slat used in a modified example of the illumination device illustrated in FIG. 1.

FIG. 12 is a perspective view illustrating an arrangement of an illumination device in accordance with another embodiment of the present invention.

FIG. 13 is a plan view illustrating a planar arrangement of a slat which is a part of the arrangement of the illumination device illustrated in FIG. 12.

FIG. 14 is a fragmentary cross-sectional view illustrating the slat which is a part of the arrangement of the illumination device illustrated in FIG. 12, taken along a cutting-plane line A-A′.

FIG. 15 is a cross-sectional view illustrating details of the arrangement of the slat provided in the illumination device illustrated in FIG. 12.

FIG. 16 is a view illustrating how a shape of the slat provided in the illumination device illustrated in FIG. 12 is changed.

FIG. 17 is a view illustrating an arrangement of a modified example of an illumination device in accordance with one embodiment of the present invention.

FIG. 18 is a view illustrating an arrangement of an illumination device in accordance with another embodiment of the present invention.

FIG. 19 is a fragmentary cross-sectional view illustrating a slat which is a part of the arrangement of the illumination device illustrated in FIG. 18, taken along a cutting-plane line A-A′.

FIG. 20 is a view illustrating an arrangement of a modified example of an illumination device in accordance with one embodiment of the present invention.

FIG. 21(a) is a plan view illustrating a planar arrangement of a slat which is a part of the arrangement of the illumination device illustrated in FIG. 20.

FIG. 21(b) is a plan view illustrating a planar arrangement of a slat which is a part of the arrangement of the illumination device illustrated in FIG. 20.

FIG. 22(a) is a cross-sectional view illustrating a shape of a slat pressure member for changing a shape of the slat provided in the illumination device illustrated in FIG. 1.

FIG. 22(b) is a cross-sectional view illustrating a shape of a slat pressure member for changing a shape of the slat provided in the illumination device illustrated in FIG. 1.

FIG. 22(c) is a cross-sectional view illustrating a shape of a slat pressure member for changing a shape of the slat provided in the illumination device illustrated in FIG. 1.

FIG. 23 is a view illustrating a conventional arrangement.

FIG. 24 is a view illustrating a driving circuit employing a voltage-driving digital-gray scale method, as an example of a driving method in accordance with one embodiment of the present invention.

### DESCRIPTION OF EMBODIMENTS

An illumination device of the present invention includes a plurality of slats so that the plurality of slats are movable rotatably forward and backward and are arranged in parallel with each other. Each of the plurality of slats has flexibility, and includes an organic EL element (light-emitting element) which has such an arrangement that an organic layer including an organic light-emitting layer is provided between a first electrode and a second electrode.

The illumination device can be used as an indoor illumination device. Further, other than this, the illumination device can be used as what is called a blind or a screen, which adjusts how much light is let in a room from a window.

### Embodiment 1

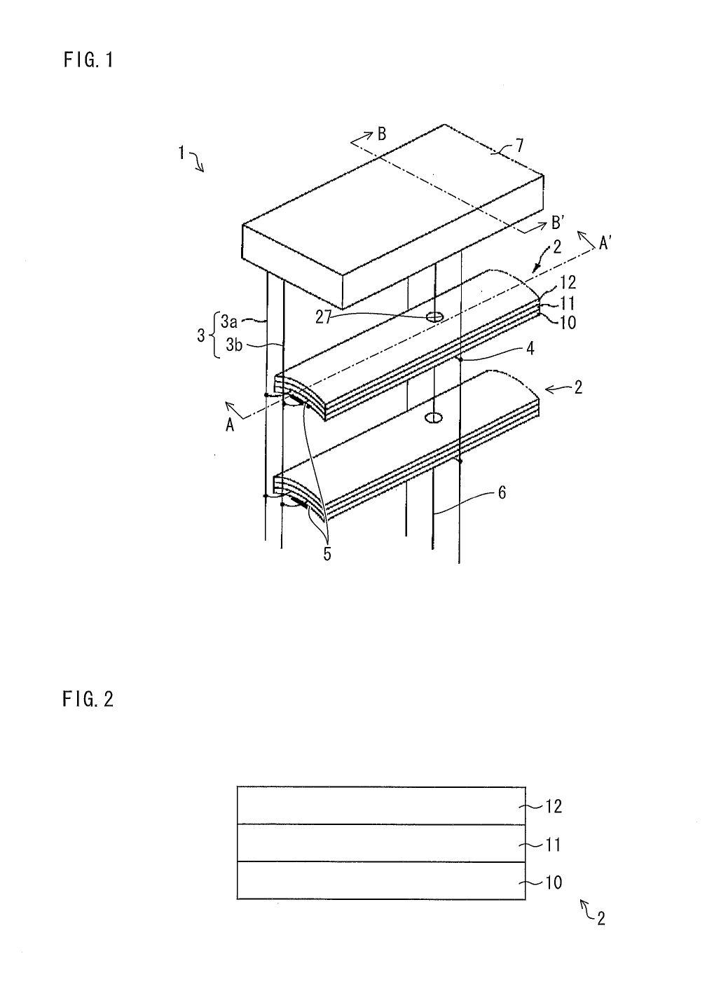

The following description deals with an arrangement of an illumination device in accordance with one embodiment of the present invention with reference to FIGS. 1 through 10, mainly, (i) details of an arrangement of a slat provided in the illumination device of the present embodiment, and (ii) a method of manufacturing the slat.

### [1] Arrangement of Illumination Device

FIG. 1 is a perspective view illustrating an arrangement of the illumination device of the present embodiment. An illumination device 1 is a horizontal blind in which a plurality of slats, each having a rectangular shape, are arranged in a vertical direction while a longitudinal direction of each of the plurality of slats is parallel to a horizontal direction. Further, FIG. 2 is a fragmentary cross-sectional view illustrating a slat 2 illustrated in FIG. 1, taken along a cutting-plane line A-A′.

The illumination device 1 of the present embodiment includes a plurality of slats 2, a wiring group (a first conductive wire, a second conductive wire) 3, a support wire (supporting section) 4, a plurality of slat pressure members (structures) 5, an up-and-down code 6, and a head box 7 including a power supply device (see FIG. 1). The following description deals with details of each component.

### (1) Slat

The slat 2 is a plate member having flexibility, and includes an organic EL element. The slat 2 is called “blade” of a blind, in some cases.

Further, the slat 2 has a through-hole 27 as illustrated in FIG. 1, and the up-and-down code 6 extends through the through-hole 27. The through-hole 27 of the slat 2 can be formed in a region where a light-emitting section 11 is formed, or in an end region of the slat 2, in which end region the light-emitting section 11 is not formed.

Details of the slat 2 are described below with reference to FIGS. 1 and 2. The slat 2 includes a substrate 10, the light-emitting section 11, and a sealing section 12 (see FIG. 2). The light-emitting section 11 is provided on one of surfaces of the substrate 10, and the sealing section 12 is provided on the light-emitting section 11.

### [Substrate]

The substrate 10 is an insulating substrate having a rectangular shape (see FIG. 1).

Examples of the substrate 10 encompass (i) an inorganic substrate made from glass, quartz, or the like, (ii) a plastic substrate made from polyethylene terephthalate, polycarbazole, polyimide, or the like, (iii) an insulating substrate such as a ceramics substrate made from alumina or the like, (iv) a metal substrate made from aluminum (Al), iron (Fe), or the like, (v) a substrate obtained in such a manner that a surface of any one of the substrates described above is coated with an insulating material made from silicon oxide (SiO₂), an organic insulating material, or the like, and (vi) a substrate obtained in such a manner that a surface of a metal substrate made from Al or the like is subjected to an insulating process by an anodic oxidation method or the like. The present invention is not limited to these substrates. However, according to the present embodiment, it is preferable to employ the plastic substrate or the metal substrate, because these substrates can be bent without stress in a bending process (described later). Further, it is more preferable to employ (i) such a substrate that a plastic substrate is coated with an inorganic material or (ii) such a substrate that a metal substrate is coated with an inorganic insulating material. With such a plastic substrate coated with an inorganic material, it becomes possible to solve a problem of deterioration of the light-emitting section 11 due to transmission of water, which problem is a biggest problem raised in a case where a plastic substrate is used as the substrate 10 of the slat 2. Further, with such a metal substrate coated with an inorganic insulating material, it becomes possible to solve a problem of a leakage (short-circuit) due to a projection of the metal substrate (it has been known that, since a film thickness of the organic EL is significantly small (approximately in a range of 100 nm to 200 nm), a projection often causes a leakage (short-circuit) of a current in a pixel section), which problem is a biggest problem raised in a case where a metal substrate is used as an organic EL substrate.

Further, in a case where a transparent substrate or a translucent substrate is used as the substrate 10, it becomes possible to take light emitted from the light-emitting section (described later) to an outside of the slat 2 via the substrate 10.

Furthermore, a shape of the substrate 10 is not limited to a planar shape. The substrate 10 can have such a curved plate shape that a center part of a cross section is slightly projected from both end sections of the cross section in a case where the substrate 10 (slat 2) is cut along a direction vertical to a longitudinal direction of the rectangular shape of the substrate 10 (slat 2).

### [Light-Emitting Section]

The light-emitting section 11 is a part serving as a light source of the illumination device of the present embodiment.

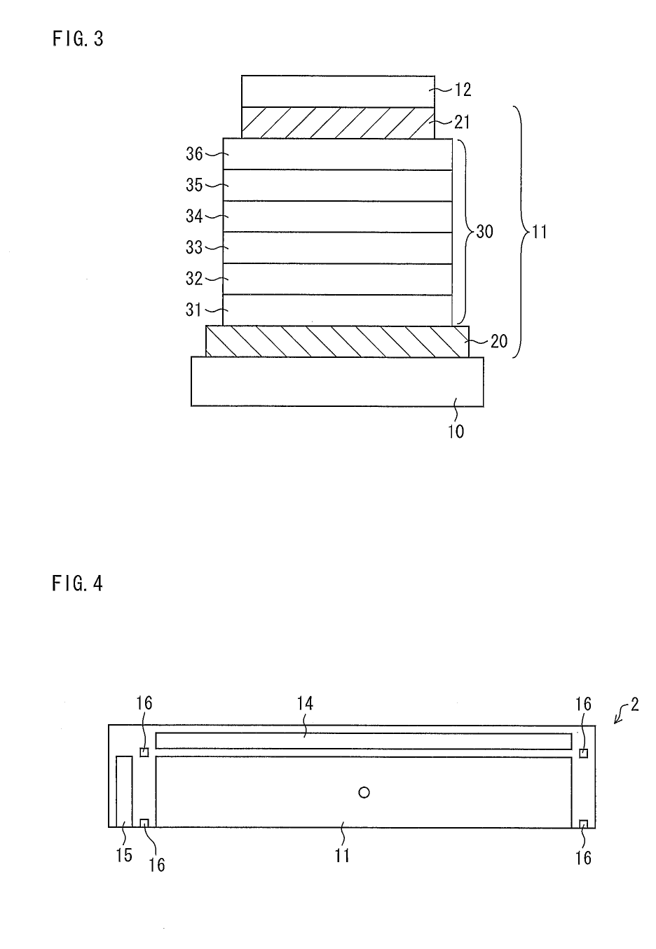

Here, FIG. 3 is a cross-sectional view illustrating details of an arrangement of a cross section of the slat 2 illustrated in FIG. 2.

The light-emitting section 11 has a rectangular shape, and includes a plurality of organic EL elements (light-emitting elements) (see FIG. 3). Each of the organic EL elements has such an arrangement that, on the substrate 10 described above, a first electrode 20, an organic layer 30 (which includes at least an organic light-emitting layer made from an organic light-emitting material), and a second electrode 21 are stacked in this order.

With an arrangement in which a plurality of organic EL elements each having an organic red light-emitting layer, an organic green light-emitting layer, and an organic blue light-emitting layer are arranged, the light-emitting section 11 can emit light in full color. Further, white light can be emitted by employing (i) an organic EL element in which an organic yellow light-emitting layer and the organic blue light-emitting layer are stacked with each other, or (ii) an organic EL element in which the organic red light-emitting layer, the organic green light-emitting layer, and the organic blue light-emitting layer are stacked with each other.

In the present embodiment, the light is emitted from the light-emitting section 11 so as to travel toward a side opposite to the substrate 10, that is, travel through the sealing section 12 to the outside. In other words, the illumination device 1 is such a top-emission illumination device that light is emitted from an upper surface of each of the plurality of slats 2 illustrated in FIG. 1.

Note that, in addition to the first electrode 20, the organic layer 30, and the second electrode 21, it is possible to provide (i) an insulating edge cover (not illustrated in FIG. 3) for preventing a leakage at an edge part of the first electrode 20 and (ii) an insulating partition layer (not illustrated in FIG. 3) for retaining a functional material solution, which is applied to produce the organic layer 30 by a wet process. In this case, the insulating edge cover and the insulating partition layer are provided on the first electrode 20 in this order, and then the organic layer 30 and the second electrode 21 are provided on these in this order.

Organic Layer

The organic layer 30 illustrated in FIG. 3 can be either a single organic light-emitting layer (single layer structure) or a combination (multilayer structure) of the organic light-emitting layer and a charge transport layer. Specifically, examples of the structure of the organic layer encompass the following structures 1) through 9).

1) Organic light-emitting layer
2) Hole-transport layer/organic light-emitting layer
3) Organic light-emitting layer/electron-transport layer
4) Hole-transport layer/organic light-emitting layer/electron-transport layer
5) Hole-injection layer/hole-transport layer/organic light-emitting layer/electron-transport layer
6) Hole-injection layer/hole-transport layer/organic light-emitting layer/electron-transport layer/electron-injection layer
7) Hole-injection layer/hole-transport layer/organic light-emitting layer/hole-blocking layer/electron-transport layer
8) Hole-injection layer/hole-transport layer/organic light-emitting layer/hole-blocking layer/electron-transport layer/electron-injection layer
9) Hole-injection layer/hole-transport layer/electron-blocking layer/organic light-emitting layer/hole-blocking layer/electron-transport layer/electron-injection layer

Note, however, that the present invention is not limited to these. Further, each of the aforementioned layers, namely, the organic light-emitting layer, the hole-injection layer, the hole-transport layer, the hole-blocking layer, the electron-blocking layer, the electron-transport layer, and the electron-injection layer, can have either a single layer structure or a multilayer structure.

Here, in FIG. 3, the aforementioned structure 8) is employed. That is, a hole-injection layer 31, a hole-transport layer 32, an organic light-emitting layer 33, a hole-blocking layer 34, an electron-transport layer 35, and an electron-injection layer 36 are provided in this order from the first electrode 20 to the second electrode 21.

The organic light-emitting layer 33 can be made from only an organic light-emitting material (examples of which are described below), or made from a combination of a light-emitting dopant and a host material. Further, the organic light-emitting layer 33 can contain a hole-transport material, an electron-transport material, an additive (a donor, an acceptor, etc.), and/or the like, if necessary, and can have such an arrangement that such a material(s) is dispersed in a polymer material (a binding resin) or in an inorganic material. In view of light-emitting efficiency and a lifetime, it is preferable to use such a material that a light-emitting dopant is dispersed in a host material.

As the organic light-emitting material, a known light-emitting material for organic EL can be used. Examples of such a light-emitting material encompass a low-molecular light-emitting material and a polymer material. Specific examples of these materials are described below. Note, however, that the present invention is not limited to these. Further, the light-emitting material may be a fluorescent material, a phosphorescent material, or the like. In view of low power consumption, it is preferable to use the phosphorescent material which has high light-emitting efficiency.

Here, specific compounds are described below. Note, however that the present invention is not limited to these materials.

Examples of the low-molecular organic light-emitting material encompass (i) a fluorescent organic material such as an aromatic dimethylidene compound (such as 4,4′-bis(2,2′-diphenylvinyl)-biphenyl (DPVBi)), an oxaziazol compound (such as 5-methyl-2-[2-[4-(5-methyl-2-benzoxazolyl)phenyl]vinyl]benzoxazole), a triazole derivative (such as 3-(4-biphenylyl)-4-phenyl-5-t-butylphenyl-1,2,4-triazol (TAZ)), a styrylbenzene compound (such as 1,4-bis(2-methylstyryl)benzene), a thiopyridine dioxide derivative, a benzoquinone derivative, a naphthoquinone derivative, an antraquinone derivative, a diphenoquinone derivative, and a fluorenone derivative, and (ii) a fluorescent light-emitting organic metal complex such as an azomethine zinc complex and (8-hydroxyquinolinato)aluminum complex (Alq₃)).

Examples of a material of the polymer light-emitting material encompass (i) a polyphenylenevinylene derivative (such as poly(2-decyloxy-1,4-phenylene) (DO-PPP), poly[2,5-bis-[2-(N,N,N-triethylammonium) ethoxy]-1,4-phenyl-alt-1,4-phenylene]dibromide (PPP-NEt3+), poly[2-(2′-ethylhexyloxy)-5-methoxy-1,4-phenylenevinylene] (MEH-PPV), poly [5-methoxy-(2-propanoxysulfonide)-1,4-phenylenevinylene](MPS-PPV), and poly[2,5-bis-(hexyloxy)-1,4-phenylene-(1-cyanovinylene)] (CN-PPV)), and a polyspiro derivative (such as poly (9,9-dioctyl fluorene) (PDAF)).

As the light-emitting dopant which is contained in the organic light-emitting layer 33, if necessary, a known dopant material for organic EL can be used. Examples of such a dopant material encompass a fluorescent light-emitting material (such as a styryl derivative, perylene, an iridium complex, a coumarin derivative, Lumogen F Red, dicyanomethylene pyran, phenoxazine, and a porphyrin derivative), and a phosphorescent light-emitting organic metal complex (such as bis [(4,6-difluorophenyl)-pyridinato-N,C2′]picolinate iridium (III) (FIrpic), tris(2-phenyl pyridyl)iridium (III) (Ir(ppy)₃), and tris(1-phenylisoquinoline) iridium (III) (Ir(piq)₃)).

Further, as the host material used with the dopant, a known host material for organic EL can be used. Examples of such a host material encompass the aforementioned examples of the low-molecular light-emitting material, the aforementioned examples of the polymer light-emitting material, and a carbazole derivative (such as 4,4′-bis(carbazole)biphenyl, 9,9-di(4-dicarbazole-benzyl)fluorene (CPF)).

Furthermore, in order to carry out injection of an electric charge (hole, electron) from an electrode and transport (injection) of the electric charge into the organic light-emitting layer, the charge-injection/transport layer can be used. Examples of the charge-injection/transport layer encompass a charge injection layer (the hole-injection layer 31, the electron-injection layer 36) and a charge transport layer (the hole-transport layer 32, the electron-transport layer 35). The charge-injection/transport layer can be made from only a charge injection/transport material (examples of which are described below), or can additionally contain an additive (a donor, an acceptor, etc.) or the like, if necessary. The charge-injection/transport layer can have an arrangement in which such a material(s) is dispersed in a polymer material (binding resin) or in an inorganic material.

As the charge-injection/transport material, a known charge-transport material for organic EL or a known charge-transport material for an organic photo conductor can be used. Examples of the charge-injection/transport material encompass a hole-injection/transport material and an electron-injection/transport material. Specific examples of these are described below. Note, however, that the present invention is not limited to these materials.

Examples of the hole-injection/transport material encompass (i) a low-molecular material such as an oxide (such as vanadium oxide (V₂O₅) and molybdenum oxide (MoO₂)), an inorganic p-type semiconductor material, a porphyrin compound, an aromatic tertiary amine compound (such as N,N′-bis(3-methylphenyl)-N,N′-bis(phenyl)-benzidine (TPD) and N,N′-di(naphthalene-1-yl)-N,N′-diphenyl-benzidine (NPD)), a hydrazone compound, a quinacridone compound, and a styrilamine compound, and (ii) a polymer material (such as polyaniline (PANI), polyaniline-camphor sulfonic acid (PANI-CSA), 3,4-polyethylene dioxy thiophene/polystylene sulfonate (PEDOT/PSS), a poly(triphenyl amine) derivative (Poly-TPD), and polyvinyl carbazole (PVCz), poly (p-phenylenevinylene) (PPV), and poly (p-naphthalenevinylene (PNV)).

Further, in view of efficiency in carrying out the injection/transport of a hole from an anode, it is preferable that the hole-injection layer is made from a material having a lower energy level of a highest occupied molecular orbital (HOMO) than that of the hole-injection/transport material of the hole-transport layer, and (ii) the hole-transport layer is made from a material having a higher mobility of a hole than that of the hole-injection/transport material of the hole-injection layer.

Furthermore, in order to improve properties of the injection/transport of a hole, it is preferable that the hole-injection/transport material is doped with an acceptor. As the acceptor, a known acceptor material for organic EL can be used. Specific examples of such an acceptor material are described below. Note, however, that the present invention is not limited to these materials.

Examples of the acceptor material encompass (i) an inorganic material (such as Au, Pt, W, Ir, POCl₃, AsF₆, Cl, Br, I, vanadium oxide (V₂O₅), and molybdenum oxide (MoO₂)), and (ii) an organic material such as a compound having a cyano group (such as TCNQ (7,7,8,8,-tetracyanoquinodimethane), TCNQF₄ (tetrafluorotetracyanoquinodimethane), TCNE (tetracyanoethylene), HCNB (hexacyanobutadiene), and DDQ (dicyclodicyanobenzoquinone)), a compound having a nitro group (such as TNF (trinitrofluorenone) and DNF (dinitrofluorenone)), fluoranil, chloranil, and bromanil. Among these, the compound having a cyano group (such as TCNQ, TCNQF₄, TCNE, HCNB, and DDQ) can effectively increase a carrier concentration, and it is therefore preferable to employ, as the acceptor material, the compound having a cyano group.

Examples of the electron-injection/transport material encompass (i) an inorganic material which is an n-type semiconductor, (ii) a low-molecular material (such as an oxadiazole derivative, a triazole derivative, a thiopyrazinedioxido derivative, a benzoquinone derivative, a naphthoquinone derivative, an antraquinone derivative, a diphenoquinone derivative, a fluorenone derivative, and a benzodifuran derivative), and (iii) a polymer material (such as poly(oxadiazole) (Poly-OXZ), and a polystyrene derivative (PSS)). Particularly, the electron-injection material may be a fluoride (such as lithium fluoride (LiF) and barium fluoride (BaF₂)) or an oxide (such as lithium oxide (Li₂O)), for example.

In view of efficiency in carrying out the injection/transport of an electron from a cathode, it is preferable to (i) employ, as a material of the electron-injection layer 36, a material having a higher energy level of a lowest unoccupied molecular orbital (LUMO) than that of the electron-injection/transport material of the electron-transport layer 35, and (ii) employ, as a material of the electron-transport layer 35, a material having a higher mobility of an electron than that of the electron-injection/transport material of the electron-injection layer 36.

Further, in order to improve properties of the injection/transport of the electron, it is preferable that the electron-injection/transport material is doped with a donor. As the donor, a known donor material for organic EL can be used. Specific examples of the donor material are described below. Note, however, that the present invention is not limited to these materials.

Examples of such a donor material encompass (i) an inorganic material (such as an alkali metal, an alkali earth metal, a rare-earth element, Al, Ag, Cu, and In), and (ii) an organic material such as a compound having an aromatic tertiary amine as its skeleton (such as aniline series, phenylenediamine series, benzidine series (such as N,N,N′,N′-tetraphenylbenzidine, N,N′-bis-(3-methylphenyl)-N,N′-bis-(phenyl)-benzidine, and N,N′-di(naphthalene-1-yl)-N,N′-diphenyl-benzidine), triphenylamine series (such as triphenylamine, 4,4′4″-tris (N,N-diphenyl-amino)-triphenylamine, 4,4′4″-tris (N-3-methylphenyl-N-phenyl-amino)-triphenylamine, and 4,4′4″-tris(N-(1-naphthyl)-N-phenyl-amino)-triphenylamine), triphenyldiamine series (such as N,N′-di-(4-methyl-phenyl)-N,N′-diphenyl-1,4-phenylenediamine)), a polycyclic compound (note that the polycyclic compound here can have a substituent group) (such as phenanthrene, pyrene, perylene, anthracene, tetracene, and pentacene), TTF (tetrathiafulvalene) series, dibenzofuran, phenothiadine, and carbazole). Among these, the compound having an aromatic tertiary amine as its skeleton, the polycyclic compound, and the alkali metal can effectively increase a carrier concentration, and it is therefore preferable to employ one of these materials as the donor material.

The organic layer 30, constituted by the hole-injection layer 31, the hole-transport layer 32, the organic light-emitting layer 33, the hole-blocking layer 34, the electron-transport layer 35, and the electron-injection layer 36, can be formed by a known wet process by use of solutions for forming an organic layer, in each of which a corresponding one of the aforementioned materials is dissolved and dispersed in a solvent. Examples of a known wet process encompass a coating method (such as a spin coat method, a dipping method, a doctor blade method, a discharge coat method, and a spray coat method), and a printing method (such as an ink-jet method, a relievo printing method, an intaglio printing method, a screen printing method, and a micro gravure coat method). The organic layer 30 can be also formed, by use of the aforementioned materials, by a dry process (such as a resistance heating vapor-deposition method, an electron-beam (EB) vapor-deposition method, a molecular beam epitaxy (MBE) method, a sputtering method, and an organic vapor-phase deposition (OVPD) method), a laser transfer method, or the like. In a case where the organic layer 30 is formed by the wet process, the solution for forming the organic layer 30 may contain an additive (such as a leveling agent and a viscosity adjusting agent) for adjusting a physicality of the solution.

Generally, the organic layer 30 has a film thickness in a range of 1 nm to 1000 nm. It is preferable that the organic layer 30 has a film thickness in a range of 10 nm to 200 nm. In a case where the organic layer 30 has a film thickness of less than 10 nm, it is difficult to realize an originally-desired physicality (an electron injection characteristic, an electron transport characteristic, and an electron confinement property). Further, there is a risk that a pixel might have a defect due to a foreign substance such as dust. Meanwhile, in a case where the organic layer 30 has a film thickness of more than 200 nm, there is an increase in driving voltage due to a resistance component of the organic layer 30. The increase in driving voltage leads to an increase in power consumption.

First Electrode and Second Electrode

The first electrode 20 and the second electrode 21, illustrated in FIG. 3, serve as a pair of electrodes, namely, an anode and a cathode of the organic EL element. That is, in a case where the first electrode 20 serves as the anode, the second electrode 21 serves as the cathode. In a case where the first electrode 20 serves as the cathode, the second electrode 21 serves as the anode.

The first electrode 20 includes a terminal which is coupled with a conductive wire group 3 (described later) so as to receive a voltage from a power supply device 7 via the conductive wire group 3. The second electrode 21 includes a terminal which is coupled with the conductive wire group 3 so as to receive a voltage from the power supply device 7 via the conductive wire group 3. As illustrated in FIG. 4, a terminal 14 of the first electrode 20 is provided along one of long sides of the slat 2 having a rectangular shape, and a terminal 15 of the second electrode 21 is provided along one of short sides of the slat 2 having a rectangular shape.

The following description deals with specific compounds used as the first electrode 20 and the second electrode 21, and specific methods for forming the first electrode 20 and the second electrode 21. Note, however, that the present invention is not limited to these materials and methods.

As an electrode material of the first electrode 20 and the second electrode 21, a known electrode material can be used. In view of efficiency in carrying out the injection of a hole into the organic light-emitting layer 33, examples of a material of the anode (transparent electrode) encompass a metal having a work function of not less than 4.5 eV (such as gold (Au), platinum (Pt), and nickel (Ni)), an oxide (ITO) which has a work function of not less than 4.5 eV and is made of indium (In) and tin (Sn), an oxide (SnO₂) of tin (Sn), which has a work function of not less than 4.5 eV, and an oxide (IZO) which has a work function of not less than 4.5 eV and is made of indium (In) and zinc (Zn). Further, in view of efficiency in carrying out the injection of an electron into the organic light-emitting layer 33, examples of an electrode material of the cathode encompass a metal having a work function of not more than 4.5 eV (such as lithium (Li), calcium (Ca), cerium (Ce), barium (Ba), and aluminum (Al)), an Mg:Ag alloy which has a work function of not less than 4.5 eV and contains at least one of the metals, and an Li:Al alloy which has a work function of not less than 4.5 eV and contains at least one of the metals.

The first electrode 20 and the second electrode 21 can be formed, by use of at least one of the materials described above, by a known method such as an EB vapor-deposition method, a sputtering method, an ion plating method, and a resistance heating vapor-deposition method. Note, however, that the present invention is not limited to these methods. Further, it is possible to develop, if necessary, a pattern of the electrode thus formed by use of a photolithography method and a laser abrasion method. It is also possible to form directly, by combination of s pattern and a shadow mask, the electrode whose pattern has been developed. It is preferable that each of the electrodes has a film thickness of not less than 50 nm. In a case where the film thickness of the first electrode 20 or the second electrode 21 is less than 50 nm, a wiring resistance becomes high. In this case, there is a risk that the driving voltage might be increased.

In order to take out the light emitted from the organic light-emitting layer 33 from the front side (the upper side in FIG. 1) of the slat 2 (see FIG. 1), it is preferable that the second electrode 21 is a transparent or translucent electrode. Further, in order to take out the light emitted from the organic light-emitting layer 33 from the backside (the lower side in FIG. 1) of the slat 2, it is preferable that the first electrode 20 is a transparent or translucent electrode.

In the case of the transparent electrode, it is particularly preferable that the transparent electrode is made from ITO or IZO. It is preferable that the transparent electrode has a film thickness in a range of 50 nm to 500 nm, more preferably in a range of 100 nm to 300 nm. In a case where the transparent electrode has a film thickness of less than 50 nm, a wiring resistance becomes high. In this case, there is a risk that the driving voltage might be increased. Meanwhile, in a case where the transparent electrode has a film thickness of more than 500 nm, there is a reduction in light transmittance. In this case, there is a risk that a luminance might be reduced.

Furthermore, in a case where (i) a microcavity (interference) effect is employed for the purpose of an improvement in color purity, an improvement in light-emitting efficiency, etc., and (ii) the light emitted from the organic light-emitting layer is taken out from a first electrode 20 (second electrode 21) side, it is preferable to use a translucent electrode as the first electrode 20 (second electrode 21). It is possible that the translucent electrode is made from either only a metal translucent electrode, or a combination of a metal translucent electrode and a transparent electrode material. However, in view of reflectivity and transmittance, it is preferable that the translucent electrode is made from silver. It is preferable that the translucent electrode has a film thickness in a range of 5 nm to 30 nm. In a case where the translucent electrode has a film thickness of less than 5 nm, reflection of the light is not sufficiently carried out. In this case, it is impossible to obtain a sufficient interference effect. Meanwhile, in a case where the translucent electrode has a film thickness of more than 30 nm, there is a significant reduction in light transmittance. In this case, there is a risk that the luminance and the light-emitting efficiency might be reduced.

Here, in a case where the light emitted from the organic light-emitting layer is taken out from the first electrode 20 (second electrode 21), it is preferable to employ, as the second electrode 21 (first electrode 20), an electrode which does not transmit light. Examples of such en electrode encompass a black electrode (such as tantalum and carbon), a reflective metal electrode (such as aluminum, silver, gold, an aluminum-lithium alloy, an aluminum-neodymium alloy, and an aluminum-silicon alloy), and an electrode in which a transparent electrode and the reflective metal electrode (reflecting electrode) are combined with each other.

Edge Cover

It is possible to provide an edge cover at an edge part of the first electrode 20 in order to prevent a leakage of a current between the first electrode 20 and the second electrode 21.

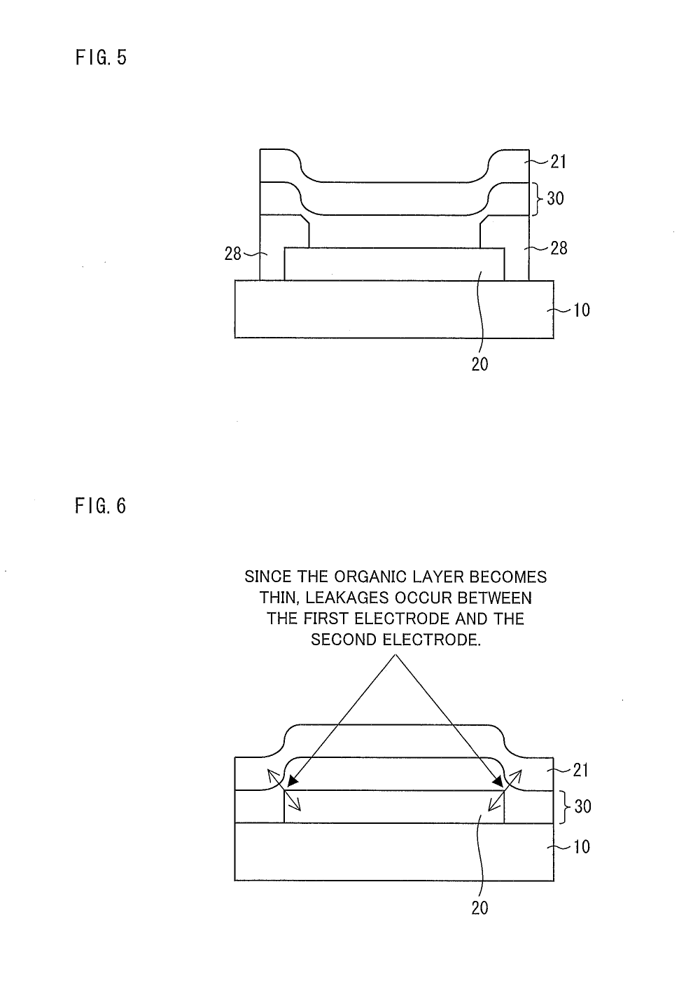

Here, the following description deals with an arrangement and effects of the edge cover with reference to FIGS. 5 and 6. FIG. 5 is a cross-sectional view illustrating an arrangement in which the edge cover is provided. FIG. 6 is a cross-sectional view illustrating a comparative arrangement with respect to the arrangement illustrated in FIG. 5. In the comparative arrangement, no edge cover is provided. An edge cover 28 is provided at an edge part of the first electrode 20 (see FIG. 5). In the case where no edge cover is provided, a thickness of the organic layer 30 becomes thin, and therefore a leakage is caused between the first electrode 20 and the second electrode 21 (see FIG. 6). The edge cover 28 can prevent such a leakage effectively.

The edge cover can be formed, by use of an insulating material, by a known method such as an EB vapor-deposition method, a sputtering method, an ion plating method, and a resistance heating vapor-deposition method. A pattern of the edge cover can be developed by a photolithography method of a known dry or wet process. Note, however, that the present invention is not limited to these methods.

As the insulating material, a known material can be used. According to the present invention, the insulating material is not particularly limited, as long as the insulating material transmits light. Examples of the insulating material encompass SiO, SiON, SiN, SiOC, SiC, HfSiON, ZrO, HfO, and LaO.

Further, it is preferable that the edge cover has a film thickness in a range of 100 nm to 2000 nm. In a case where the edge cover has a film thickness of not more than 100 nm, an insulating property becomes insufficient. In this case, a leakage might occur between the first electrode and the second electrode, and the leakage might cause an increase in power consumption and such a defect that no light is emitted. Meanwhile, in a case where the edge cover has a thickness of not less than 2000 nm, a film forming process requires a longer time period. This reduces production efficiency and also causes such a defect that a conductive wire of the second electrode 21 is broken at the edge cover.

### [Sealing Section]

In order to carry out sealing further on an outermost surface (second electrode 21), it is possible to provide, as the sealing section 12, via an inorganic film or a resin film, (i) a sealing substrate made from plastic or the like, or (ii) a sealing film (see FIG. 2).

The sealing substrate or the sealing film can be made from a known sealing material by a known sealing method. Specifically, it is possible to form the sealing substrate or the sealing film by sealing an inactive gas such as nitrogen gas and argon gas by use of glass, a metal or the like. Further, it is preferable to mix a moisture absorbent material (such as barium oxide) or the like in the inactive gas thus sealed. With the arrangement, it is possible to reduce effectively deterioration of the organic EL due to moisture. Furthermore, it is also possible to form the sealing film by spraying or attaching a resin onto the second electrode 21 by a spin coat method, an ODF method, or a laminating method. Moreover, it is also possible to form the sealing film in such a manner that (i) an inorganic film (such as SiO, SiON, and SiN) is formed on the second electrode 21 by a plasma CVD method, an ion plating method, an ion beam method, or a sputtering method, and then (ii) a resin is further applied to or attached to the inorganic film by a spin coat method, an ODF method, or a laminating method. This sealing film can prevent oxygen or moisture from being mixed in the organic EL element from an outside, so as to allow the organic EL element to have a longer lifetime. Note, however, that the present invention is not limited to these members and these methods. Further, in a case where the light emitted from the organic layer 30 is taken out from the second electrode side, i.e., from the front side of the slat 2 (the upper side in FIG. 1), it is necessary for either the sealing film or the sealing substrate to be made from an optically transparent material.

Note that it is not essential to provide the sealing substrate. It is possible to carry out the sealing with only the inorganic film and the resin film.

### (2) Conductive Wire Group

The conductive wire group 3 is coupled with the power supply device provided in the head box 7 (described later), and supplies a voltage to both the terminal 14 of the first electrode 20 and the terminal 15 of the second electrode 21.

Specifically, the conductive wire group 3 is constituted by a first conductive wire 3a and a second conductive wire 3b. The first conductive wire 3a is connected to the terminal 14 of the first electrode 20, and the second conductive wire 3b is connected to the terminal 15 of the second electrode 21.

The first conductive wire 3a and the second conductive wire 3b are not particularly limited, as long as these can transmit an input signal received from the power supply device 7. The first conductive wire 3a and the second conductive wire 3b may be made from a known material. Examples of the material of the first conductive wire 3a and the second conductive wire 3b encompass copper, silver, gold, and aluminum. Further, the material is not limited to an inorganic material. The first conductive wire 3a and the second conductive wire 3b may be made from an organic material.

### (3) Support Wire

A support wire 4 is a wire for supporting all of the plurality of slats 2 of the illumination device 1 illustrated in FIG. 1, and can adjust an inclined angle of the plurality of slats 2 by causing the plurality of slats 2 to move rotatably forward and backward. The “wire” means a member having a line shape like a code, a thread, and a string. It is preferable to provide a plurality of support wires 4 so that the plurality of support wires 4 are arranged with predetermined intervals along a longitudinal direction of each of the plurality of slats 2 having a rectangular shape. For example, it is possible to provide two support wires 4 in the vicinity of both ends of each of the plurality of slats 2 having a rectangular shape, respectively, in the longitudinal direction of the slat 2. Note that the following description deals with a single support wire 4.

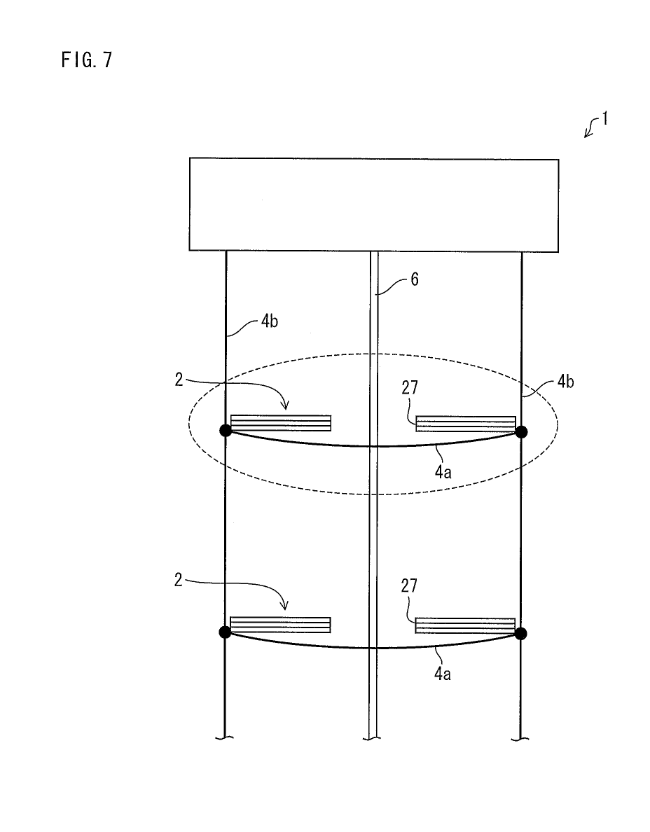

FIG. 7 is a fragmentary cross-sectional view illustrating the illumination device 1 illustrated in FIG. 1, taken along a cutting-plane line B-B′.

As illustrated in FIG. 7, the support wire 4 is constituted by a first support wire (first support member) 4a and a second support wire (second support member) 4b. The first support wire 4a extends across each of the plurality of slats 2 along one of surfaces of the slat 2, which one of surfaces is on a substrate 10 side. The second support wire 4b extends along a perpendicular (vertical) direction in which the plurality of slats 2 are arranged in parallel with each other.

The first support wire 4a extends across the slat 2 along a width (referred to as “short side” of the slat 2, in some cases) between long sides of the slat 2 having a rectangular shape. The first support wire 4a is connected to two second support wires 4b on the respective long sides of the slat 2. To the first support wire 4a, a slat pressure member 5 (described later) is attached, so as to be provided between the first support wire 4a and the slat 2.

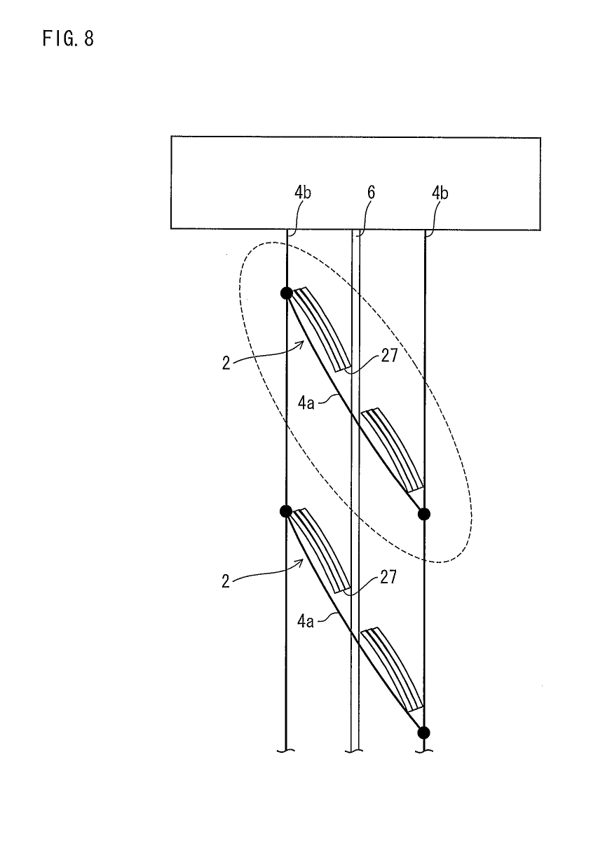

The two second support wires 4b are provided so as to sandwich the slat 2 in a direction the short sides of the slat 2 extend. At least one of the two second support wires 4b moves in an upper-lower direction (a direction perpendicular to a horizontal direction). With such movement, a difference is generated in height between one of ends of the first support wire 4a and the other one of ends of the first support wire 4a, so that the slat 2 supported by the first support wire 4a is inclined. It is therefore possible to adjust an inclined angle of the slat 2 from the state illustrated in FIG. 7 to the state illustrated in FIG. 8.

Note that the above method for adjusting the inclined angle of the slat 2 is only an example. It is also possible to employ a known conventional adjustment method for adjusting an inclined angle of a slat of a blind.

The first support wire 4a and the second support wire 4b can be made from a known material used in a general blind. Note, however, that it is preferable that the first support wire 4a and the second support wire 4b are made from a plastic material. With the use of the support wire 4 made from a plastic material, it becomes possible to give pressure to the slat 2, more successfully, by use of the slat pressure member 5.

### (4) Slat Pressure Member

The slat pressure member 5 is provided in the vicinity of one of surfaces of the slat 2, which one of surfaces is on the substrate 10 side (see FIG. 1). Specifically, the slat pressure member 5 is provided to be adjacent to a central axis of the slat 2 in the longitudinal direction of the slat 2. More specifically, the slat pressure member 5 is provided between (i) the one of surfaces of the slat 2, on the substrate 10 side, and (ii) the first support wire 4a extending across the one of surfaces of the slat 2, on the substrate 10 side.

It is preferable that a length of the slat pressure member 5 along a direction of the short sides of the slat 2 is in a range of 1/10 to ½ of a length of each short side of the slat 2, because the slat pressure member 5 having such a length can cause the slat 2 to be bent by use of a mechanism described later. In a case where the length of the slat pressure member 5 is less than 1/10 of that of the short side, it is impossible to give sufficient pressure to the slat 2. Meanwhile, in a case where the length of the slat pressure member 5 is more than ½ of that of the short side, it becomes impossible to give pressure to only the central axis part of the slat 2. In this case, it may become difficult to cause the slat 2 to be bent.

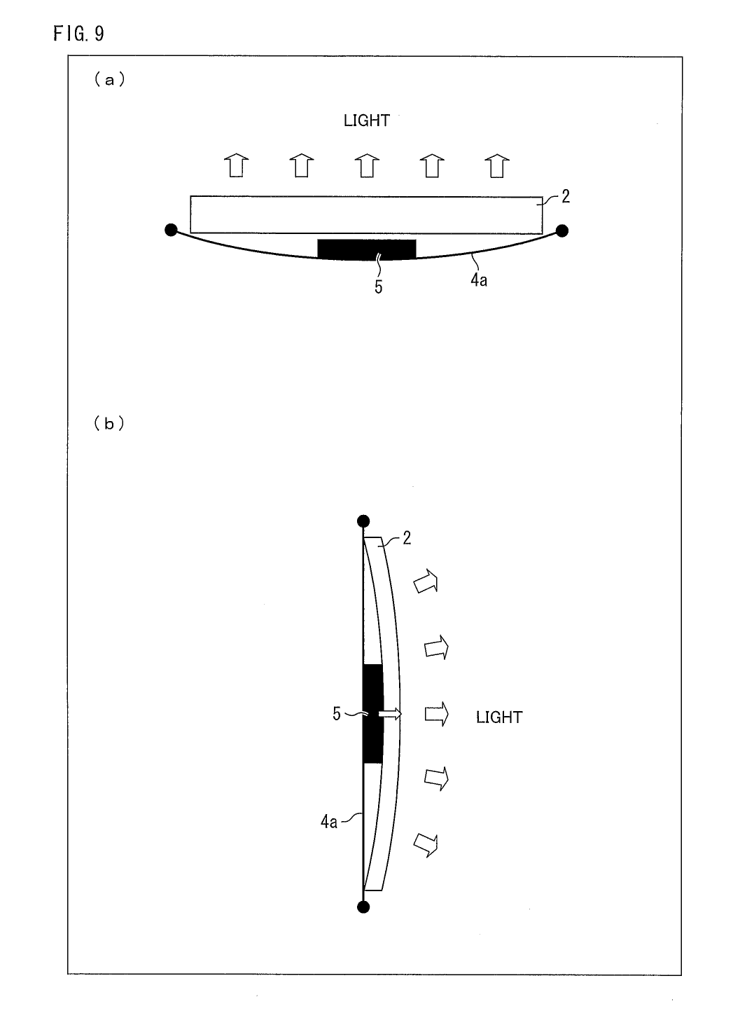

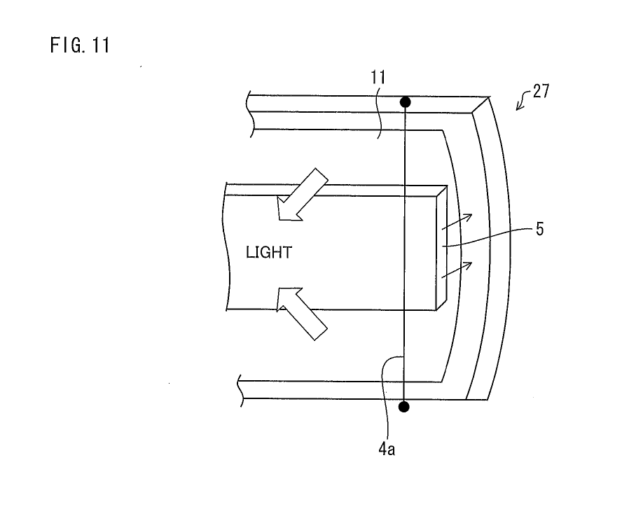

A shape of the slat pressure member 5 is not particularly limited, as long as the shape (i) has a size in the range described above and (ii) can cause the slat 2 to be bent by giving pressure to the central axis part of the slat 2 and a part in the vicinity of the central axis part of the slat 2. The shape of the slat pressure member 5 may be a rectangular solid illustrated in (a) and (b) of FIG. 9, and FIG. 11.

The slat pressure member 5 is fixed to the first support wire 4a. Note, however, that the present invention is not limited to this. The slat pressure member 5 can be fixed to the one of surfaces of the slat 2, on the substrate 10 side, or can be fixed to both (i) the first support wire 4a and (ii) the one of surfaces of the slat 2, on the substrate 10 side.

According to the present embodiment, in a case where the surfaces of the slat 2 is placed parallel to the horizontal direction, light is emitted from the light-emitting section 11 upwardly. With the arrangement, if the second support wire 4b is moved in the upper-lower direction, and, as a result, the slat 2 is inclined, a light-emitting side of the slat 2 is directed to the right side in FIG. 8. In this case, it becomes possible to emit light toward the right side in FIG. 8. In the state where the slat 2 is inclined, the slat pressure member 5 is positioned on a side (referred to as “backside”) opposite to the light-emitting side of the slat 2, and gives pressure to the slat 2 from the backside toward the light-emitting side by use of tensile force of the first support wire 4a.

This pressure mechanism is illustrated in (a) and (b) of FIG. 9. (a) of FIG. 9 is a cross-sectional view illustrating a relationship between (i) the slat 2 whose light-emitting surface faces upward, (ii) the slat pressure member 5, and (iii) the first support wire 4a. (b) of FIG. 9 is a cross-sectional view illustrating a relationship between (i) the slat 2 whose light-emitting surface faces in a lateral direction (the right side in (a) of FIG. 9), (ii) the slat pressure member 5, and (iii) the first support wire 4a. Both (a) and (b) of FIG. 9 illustrate states in the same direction as that of FIG. 7.

In the case of (a) of FIG. 9, the first support wire 4a is bent, and the slat pressure member 5 gives no pressure to the slat 2.

On the other hand, in the case of (b) of FIG. 9, the first support wire 4a is stretched, and the slat pressure member 5 is pressed toward the slat 2 by tensile force of the first support wire 4a. As a result, the slat pressure member 5 gives pressure to the slat 2.

The slat 2 receiving the pressure from the slat pressure member 5 projects toward a region opposite to a position of the slat pressure member 5. That is, only the central axis part of the slat 2 projects in a direction in which the slat 2 is pressed. As a result, the slat 2 is bent as illustrated in (b) of FIG. 9. This causes the light emitted from the slat 2 to be diffused, as compared with the light emitted from the slat 2 in a flat state illustrated in (a) of FIG. 9.

With such diffused light, it is possible to illuminate a wide region in a room.

A material of the slat pressure member 5 is not particularly limited to an organic material or an inorganic material, as long as the slat pressure member 5 can give pressure to the slat 2. However, it is preferable that the slat pressure member 5 is made from a plastic material. The plastic material may be a known material, such as polyethylene and polypropylene. Note that, in a case where the slat 2 is of a bottom-emission type (explained in the following Modified Example), the light is emitted from the other one of surfaces of the slat 2, on a slat pressure member side. In this case, it is necessary that the slat pressure member 5 is made from a material having optical transparency. Further, a shape of the slat pressure member 5 is not particularly limited, as long as the slat pressure member 5 is attached to the support wire 4.

As described above, with the arrangement in which the slat pressure member 5 is provided, the slat having flexibility can be bent in accordance with the rotational movement forward and backward. That is, it is possible to cause the shape of the slat to have a desired curvature radius reversibly. By causing the slat to have a desired curvature radius reversibly, it becomes possible to cause the light emitted from the light-emitting element of the slat to be diffused or condensed.

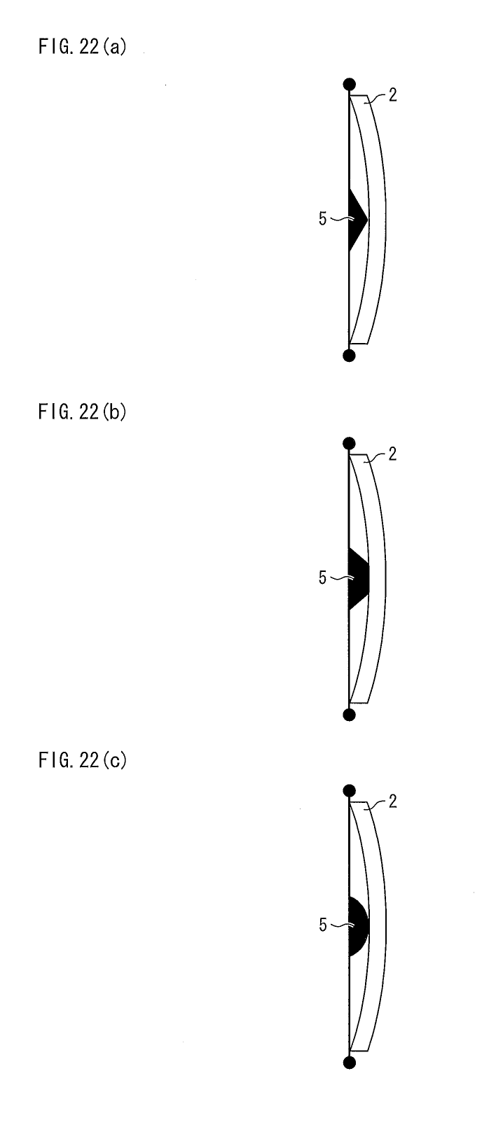

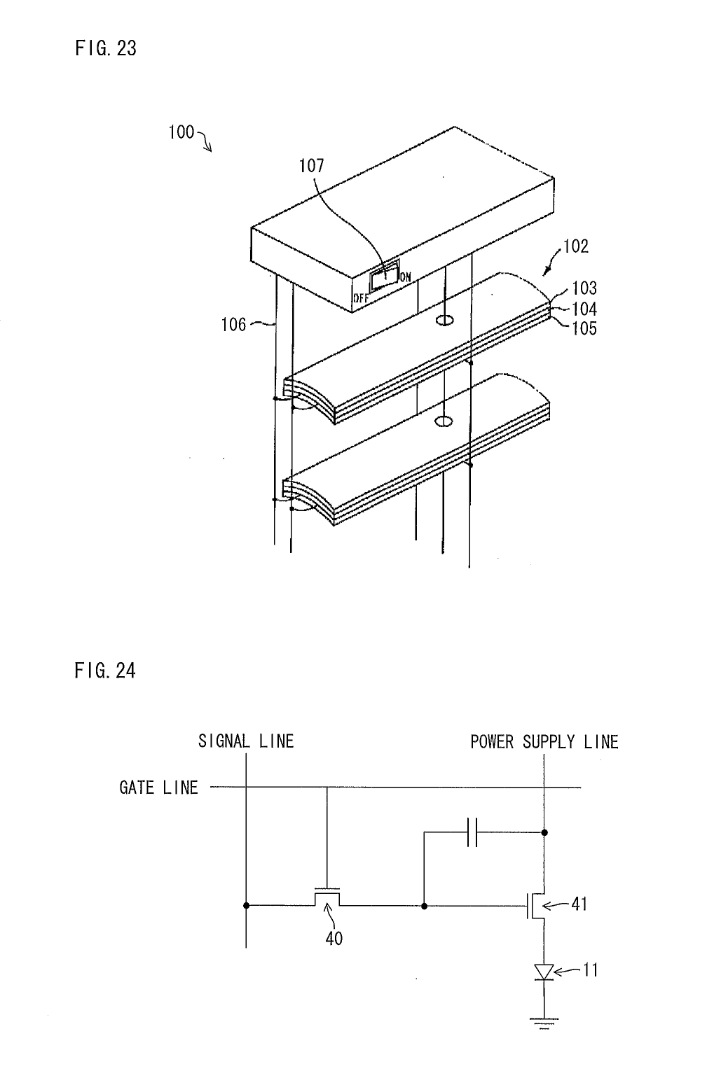

The slat pressure member 5 described above has a rectangular solid shape, and can cause the slat 2 to be bent by causing one of surfaces of the rectangular solid shape to be in contact with the one of surfaces of the slat 2. Note, however, that the present invention is not limited to this, and the shape of the slat pressure member 5 is not limited to the rectangular solid shape. For example, the slat pressure member 5 can have any one of shapes illustrated in (a) through (c) of FIG. 22, respectively. (a) through (c) of FIG. 22 illustrates the slat pressure members in the same direction as those of cross-sectional views of (a) and (b) of FIG. 9. The slat pressure member 5 illustrated in (a) of FIG. 22 has a triangle cross-section, and one of apexes of the triangle is in contact with the slat 2. Further, the slat pressure member 5 illustrated in (b) of FIG. 22 has a trapezoid cross-section, and, among two sides of the trapezoid, parallel to each other, a shorter one of the two sides is in contact with the slat 2. Furthermore, the slat pressure member 5 illustrated in (c) of FIG. 22 has a half-moon cross-section, and a curved surface of the half-moon cross-section is in contact with the slat 2. With any one of the slat pressure members 5 illustrated in (a) through (c) of FIG. 22, it is possible to reduce an area of a region of the slat pressure member 5, which region is in contact with the slat 2. Accordingly, it becomes possible to cause the slat 2 to be bent by giving relatively small pressure.

Each of these slat pressure members 5 has a straight-line contact area which is along a direction from one of short sides of the slat 2 to the other one of short sides of the slat 2. Note, however, that the present invention is not limited to this. It is possible that the slat pressure member is in contact with the slat 2 in an on-and-off manner along the direction from one of the short sides of the slat 2 to the other one of the short sides of the slat 2.

Further, it is unnecessary to cause all the plurality of slats 2 to be identical with each other in a spec of the slat pressure member 5 (e.g., a shape of the slat pressure member 5, or a position of the slat pressure member 5, relative to the slat 2). For example, by adjusting the spec of the slat pressure member 5 (the thickness of the slat pressure member 5 or a position of the slat pressure member 5, relative to the slat 2) of each of the plurality of slats 2 independently, it becomes possible to optimize a diffusing property or a condensing property of the illumination device 1 in accordance with any use environment.

### (5) Up-and-Down Code

The up-and-down code 6 is provided to adjust a length from, among the plurality of slats 2 arranged in parallel with each other, a slat 2 in an uppermost position, to a slat 2 in a lowermost position. Here, “code” is not particularly limited, like the support wire described above, as long as the code has a linear shape.

The up-and-down code 6 extends through a through-hole 27 of each of the plurality of slats 2 (see FIGS. 7 and 8). The up-and-down code 6 extends from the head box 7 to the slat 2 in the lowermost position (through, among the plurality of slats 2 arranged in parallel with each other, a slat 2 in a position closest to the head box 7, a slat 2 in a position second-closest to the head box 7, . . . to a slat 2 in a position farthest from the head box 7). One of ends of the up-and-down code 6 is fixed to the slat 2 in the position farthest from the head box 7, or fixed to a lowest end member provided below the slat 2 in the position farthest from the head box 7. By operating a roll-up section (not illustrated) of the head box 7, a length of the up-and-down code 6 is adjusted. Specifically, rolling-up is carried out from the slat 2 in the position farthest from the head box 7 or from the lowest end member, and then, in accordance with the length of the up-and-down code 6 thus adjusted, the plurality of slats 2 arranged in parallel with each other are rolled up in turns from a slat 2 in a position second-farthest from the head box 7 to the slat 2 in the position closest to the head box 7.

The up-and-down code 6 may be an up-and-down code used in a known conventional blind.

(6) Head Box in which Power Supply Device is Provided

The head box 7 constitutes an upper part of the illumination device 1 (see FIG. 1). In the head box 7, a power supply device is provided.

The power supply device is provided to drive the light-emitting section 11 of the slat 2, and includes a scan-line electrode circuit, a data signal electrode circuit, and a power supply circuit.

Here, the driving can be carried out in such a manner that the plurality of slats 2 are electrically connected to each other, and are driven collectively by an external drive circuit.

However, the present invention is not particularly limited to these, and the plurality of slats 2 can be driven as described above, or driven in such a manner that each of the plurality of slats 2 is independently connected to an external drive circuit. For example, in a case of simple matrix driving, the driving can be carried out in such a manner that (i) the terminal 14 of the first electrode 20, provided in the vicinity of one of long sides of the slat 2 having a rectangular shape, is connected to a power supply circuit via a scan line electrode circuit, and (ii) the terminal 15 of the second electrode 21, provided in the vicinity of one of short sides of the slat 2 having a rectangular shape, is connected to the power supply circuit via a data signal electrode circuit.

Further, alternatively, the driving can be carried out in such a manner that, for each of the plurality of slats 2, (i) the terminal 14 of the first electrode 20 is connected to the power supply circuit via the scan line electrode circuit, independently, and (ii) the terminal 15 of the second electrode 21 is connected to the power supply circuit via the data signal electrode circuit.

Moreover, according to the present embodiment, the light-emitting section 11 can be subjected to active matrix driving. In the case of the active matrix driving, the slat 2 includes a switching circuit (such as a TFT) in a pixel, and is electrically connected to an external drive circuit (the scan line electrode circuit (a gate driver), a data signal electrode circuit (a source driver), and a power supply circuit) so as to drive each rectangular organic EL (described later). For example, FIG. 24 illustrates such a state that (i) the driving is carried out by a voltage-driving digital gray-scale method, (ii) two TFTs, namely, a switching TFT 40 and a driving TFT 41, are provided for each of a plurality of pixels, and (iii) the driving TFT 41 is electrically connected to the first electrode provided in the light-emitting section 11 via a contact hole formed on a flattening layer. Further, in each of the plurality of pixels, a capacitor for causing a gate potential of the driving TFT 41 to be a constant potential is provided to be connected to a gate part of the driving TFT 41. On the TFTs, the flattening layer is provided. Note, however, that the present invention is not limited to these, and the driving method can be the voltage-driving digital gray-scale method, or a current-driving analogue gray-scale method. Further, the number of TFTs is not particularly limited. The light-emitting section 11 can be driven by the two TFTs as described above, or two or more conventional TFTs each of which includes a compensation circuit in a pixel in order to prevent non-uniformity in properties (mobility, threshold voltage) between the two or more TFTs. For example, in a case where (i) the illumination device is subjected to the active matrix driving, and (ii) the plurality of slats 2 are connected to each other to carry out illumination, (I) the terminal 14 (see FIG. 4) of the first electrode 20 provided in the vicinity pf one of long sides of each of the plurality of slats 2 is connected to an FPC directly and electrically (specifically, the terminal 14 of the first electrode 20 is connected to the FPC, and the FPC is connected directly and electrically), then, (II) the terminal 14 of the first electrode 20 is connected to a conventional external source driver and the terminal 15 of the second electrode 21 is connected to a conventional external gate driver. It is thus possible to carry out the active matrix driving.

Note, however, that it is also possible to carry out the driving in such a manner that (i) the terminal 14 of the first electrode 20 is connected to the conventional external gate driver and (ii) the terminal 15 of the second electrode 21 is connected to the conventional external source driver. Further, it is possible to provide the source driver and the gate driver inside a panel by manufacturing the source driver and the gate driver in the same process as a TFT process for constituting a pixel. Furthermore, it becomes possible to carry out the driving by (i) causing the terminal 14 of each of the plurality of slats 2 to the conventional external source driver, independently, and (ii) the terminal 15 of each of the plurality of slats 2 is connected to the conventional external gate driver. Moreover, it is possible to provide the source driver and the gate driver inside a panel by manufacturing the source driver and the gate driver in the same process as a TFT process for constituting a pixel.

In the present embodiment, the power supply device is provided in the head box 7. Note, however, that the present invention is not limited to this, and the power supply device may not be provided in the head box 7. For example, the illumination device can have an arrangement in which a slat has an organic EL element which (i) has a solar cell and (ii) can store electric energy in accordance with sunlight.

### [2] Operation of Illumination Device

Next, the following description briefly deals with how to operate the illumination device 1 and also how to adjust an inclined angle of the slat 2.

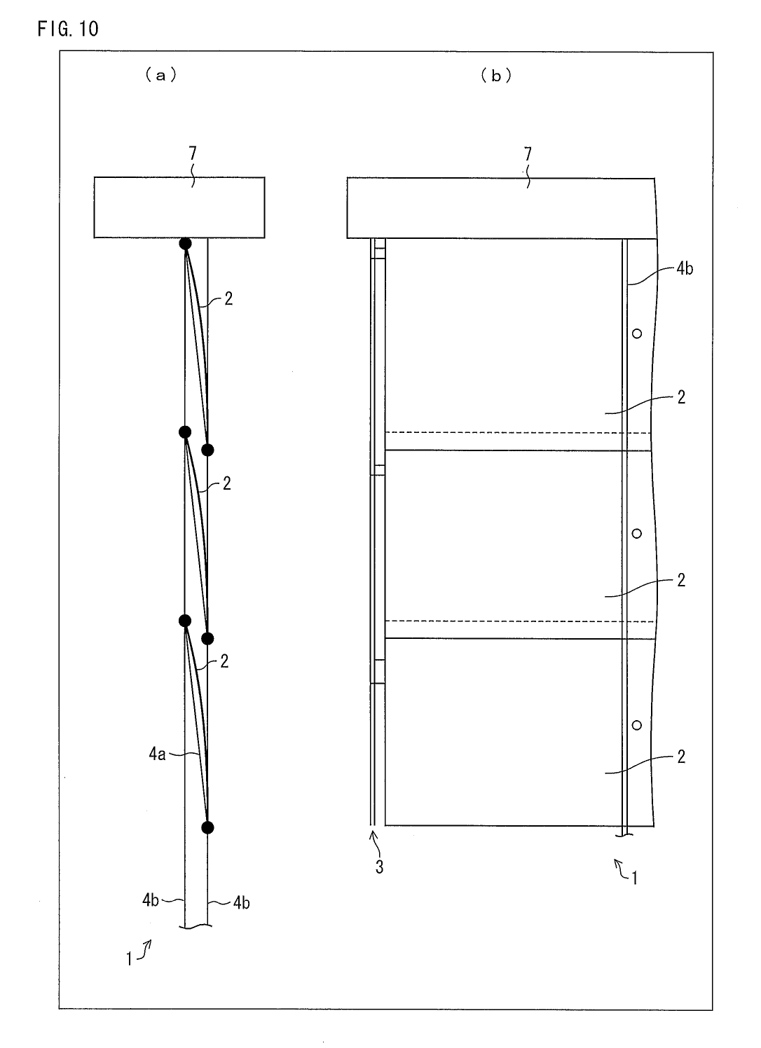

(a) and (b) of FIG. 10 illustrate a state where the inclined angle of each of the plurality of slats 2 is caused to be parallel, as much as possible, to the direction in which the plurality of slats 2 are arranged in parallel with each other, so that there is no gap between adjacent ones of the plurality of slats 2 arranged in parallel with each other. (a) of FIG. 10 is a side view, and (b) of FIG. 10 is a front view illustrating the illumination device 1, taken in such a manner that the slat 2 illustrated in (a) of FIG. 10 is viewed from the right side in (a) of FIG. 10. (a) and (b) of FIG. 10 do not illustrate all the members of the illumination device 1, for the sake of simple explanation.

By arranging the plurality of slats 2 in parallel with each other as illustrated in FIG. 10, it is possible to realize an illumination device having a large light-emitting region.

Here, a group of terminals, extending from electrodes of organic electroluminescence elements arranged in a longitudinal direction of the light-emitting section 11 having a rectangular shape, are provided to project on a back surface side of the substrate 10 in the vicinity of a border between a corresponding one of the plurality of slats 2 and an adjacent one of the plurality of slat 2 (a border of a connection section), because each of the slat 2 is bent as described above. With such an arrangement, it is possible to (i) cause the terminals not to be viewable to a viewer of the light-emitting section 11 from the connection part between adjacent ones of the plurality of slats 2, and (ii) provide a single large light-emitting surface by connecting the light-emitting sections 11 to each other without any gap between the light-emitting sections 11.

Further, in a case where the plurality of slats 2 are connected to each other as in FIG. 10, each of the plurality of slats 2 may include an alignment section in order to prevent the plurality of slats 2 from being out of alignment. For example, it is possible to provide an alignment section 16 as in FIG. 4. As illustrated in FIG. 4, the alignment section 16 can be provided in a non-light-emitting region of each of the plurality of slats 2, on the light-emitting side.

Furthermore, it is possible to connect adjacent ones of the plurality of slats 2 with high accuracy in such a manner that (i), in a part of one of the plurality of slats 2, which part is adjacent to an adjacent one of the plurality of slats 2, an alignment section 16 having a convex structure is provided, (ii), in a part of the adjacent one of the plurality of slats 2, which part is adjacent to the one of the plurality of slats 2, an alignment section 16 having a concave structure is provided, and (iii) the convex structure is inserted into the concave structure.

Note that the concave structure may be a cut-out structure (a part cut out in an up-to-down direction in FIG. 4) illustrated in a lower part of FIG. 4. Further, the alignment section 16 is not limited to the ones described above. The alignment section 16 may be a mark provided by use of a marker, or another member provided independent of the slat 2.

In the present embodiment, the light-emitting section 11 is an organic EL element. Note, however, that the present invention is not limited to this, as long as the light-emitting section 11 is a light-emitting element which (i) includes the first electrode and the second electrode, and (ii) emits light by supply of a current or by application of a voltage. For example, as the light-emitting section 11, it is possible to employ an inorganic EL element, an inorganic LED, or the like, in place of the organic EL element.

### Modified Example (1) of the Present Invention

The embodiment described above employs a top-emission type in which light is emitted from an upper surface of each of a plurality of slats 2. Note, however, that the present invention is not limited to the top-emission type. For example, it is possible to adopt such a bottom-emission type that light is emitted from a bottom surface of each of the plurality of slats 2. FIG. 11 is a perspective view illustrating (i) a slat 2′ of the bottom emission type, and (ii) a slat pressure member 5 provided to the slat 2′. A first support wire 4a extends across a bottom surface of the slat 2′, and the slat pressure member 5 is provided between the bottom surface and the first support wire 4a (see FIG. 11). In this case, as described above, it is necessary that the first electrode 20 (see FIG. 3) of the light-emitting section 11 is constituted by a transparent electrode or a translucent electrode. Further, in order not to block the light emitted from the bottom surface of the slat 2′, it is preferable that the slat pressure member 5 is made from a transparent material. By causing an inclined angle of each of the plurality of slats 2′ to be 90° with respect to a flat state (see FIG. 10), the slat pressure member 5 is pressed toward the slat 2′ by tensile force of the first support wire 4a (see FIG. 11). As a result, the slat pressure member 5 gives pressure to the slat 2′. This causes a light-emitting surface to be bent (a concave shape) (see FIG. 11). It is thus possible to realize an illumination device having a light-condensing property.

### Modified Example (2) of the Present Invention

In the embodiment described above, (i) a first support wire 4a of a support wire 4 extends across each of a plurality of slats 2 along one of surfaces of the slat 2, which one of surfaces is on a substrate 10 side, and (ii) the support wire 4 is not connected to the slat 2 (see FIGS. 7 and 8). However, the present invention is not limited to this. For example, the support wires 4 can be provided at both ends of each of the plurality of slats 2 in a longitudinal direction of the slat 2 such that (i) the first support wire 4a extends across the slat 2 along the other one of surfaces of the slat 2, which the other one of surfaces is on a sealing section 12 side, and (ii) the first support wire 4a is connected (bonded) to the other one of surfaces of the slat 2. In this case, the support wire 4 provided at a center section of the slat 2 in the longitudinal direction of the slat 2 is provided in the same manner as in FIGS. 7 and 8, that is, (i) the first support wire 4a is provided to extend across the slat 2 on one of surfaces of the slat 2 on the substrate 10 side, and (ii) the slat pressure member 5 is provided between the first support wire 4a and the slat 2.

### Embodiment 2

### Arrangement of Illumination Device

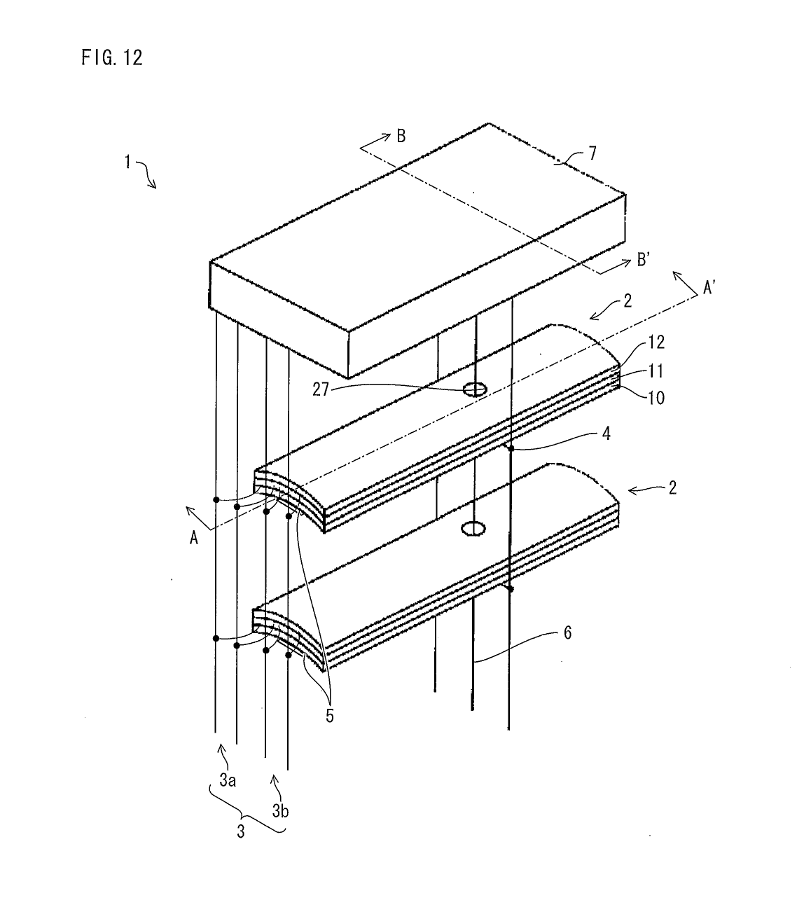

An illumination device in accordance with one embodiment of the present invention is described below with reference to FIGS. 12 through 17.

FIG. 12 is a perspective view illustrating an arrangement of an illumination device in accordance with one embodiment of the present invention.

An illumination device 1 of the present invention is a horizontal blind in which a plurality of slats each having a rectangular shape are arranged in a vertical direction while a longitudinal direction of each of the plurality of slats is parallel to a horizontal direction, in the same manner as Embodiment 1.

The illumination device 1 of the present embodiment includes a plurality of slats 2, a conductive wire group 3 (a first conductive wire, a second conductive wire, a third conductive wire, and a fourth conductive wire), a support wire 4 (a support section), a slat pressure member 5 (a structure), an up-and-down code 6, and a head box 7 in which a power supply device is provided, in the same manner as Embodiment 1 (see FIG. 12).

The illumination device 1 of the present embodiment is different from that of Embodiment 1 in (i) an arrangement of the plurality of slats 2 and (ii) a position of the conductive wire group 3.

The following description deals with each of components of the illumination device 1 of the present embodiment.

### (1) Slat

Each of the plurality of slats 2 has a through-hole 27 (see FIG. 12), and the up-and-down code 6 (described later) extends through the through-hole 27. Note that the through-hole 27 may be provided either (i) in a region where a light-emitting section 11 (described later) is formed or (ii) in a region where the light-emitting section 11 is not formed, which region is at an end region of the slat 2.

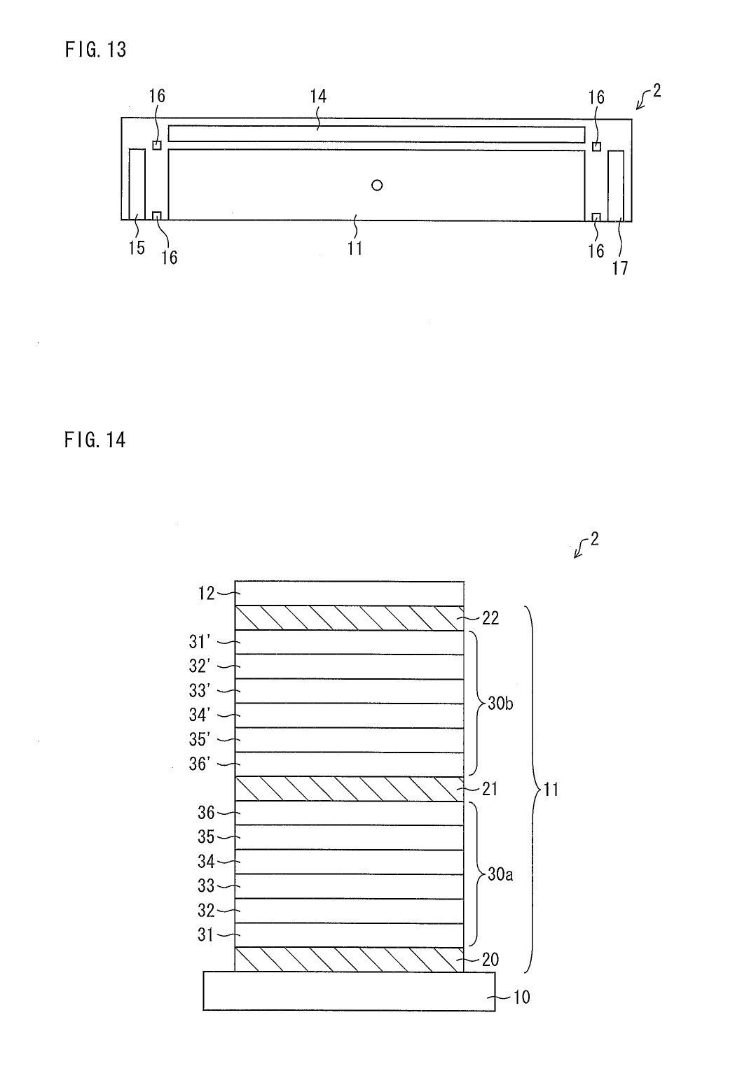

The following description deals with an arrangement of one of surfaces of the slat 2 with reference to FIG. 13. FIG. 13 is a plan view illustrating one of two slats 2 illustrated in FIG. 12. On one of surfaces of the slat 2, a light-emitting section 11 is provided to be away, inwardly, by a predetermined distance, from (i) each of a pair of short sides of four sides of the slat 2 having a rectangular shape, and (ii) one of long sides of the four sides of the slat 2 having a rectangular shape. That is, the other one of long sides of the slat 2 matches or substantially matches one of end parts of the light-emitting section 11. Further, in an area extending from the above three sides of the four sides by the predetermined distance, terminals (terminal lead-out sections) of respective electrodes, namely, a first electrode 20, a second electrode 21, and a third electrode 22 (described later), which are components of the light-emitting section 11, are provided. Specifically, as illustrated in FIG. 13, (i) a terminal 15 of the first electrode 20 (see FIG. 14) is provided along one of short sides of the slat 2 having a rectangular shape, (ii) a terminal 17 of the third electrode 22 (see FIG. 14) is provided along the other one of short sides of the slat 2 having a rectangular shape, and (iii) a terminal 14 of the second electrode 21 (see FIG. 14) is provided along one of long sides of the slat 2 having a rectangular shape.

Further, each of the plurality of slats 2 also has an alignment section 16 in a non-light-emitting region of the slat 2. A function of the alignment section 16 will be described later.

Next, the following description deals with an arrangement of a cross-section of each of the plurality of slats 2 with reference to FIG. 14. FIG. 14 is a fragmentary cross-sectional view illustrating a cross-section of the slat 2 illustrated in FIG. 12, taken along a cutting-plane line A-A′ shown in FIG. 12. Note that the terminals 14, 15, and 17 are not illustrated in FIG. 14 for the sake of simple explanation. The slat 2 includes a substrate 10, the light-emitting section 11, and a sealing section 12 (see FIG. 14). On one of surfaces of the substrate 10, the light-emitting section 11 is provided. The sealing section 12 is provided on the light-emitting section 11.

### [Substrate]

The substrate 10 has a rectangular shape, and serves as a base of the slat 2 illustrated in FIG. 13. The substrate 10 has flexibility, and is made from a material having an insulating property.

In order to take out light emitted from the light-emitting section 11 from a back surface side (a lower side in FIG. 14) of the substrate 10, it is necessary that the substrate 10 is made from a transparent material or a translucent material. Specific examples of the substrate 10 may be a transparent substrate or a translucent substrate, among substrates described in the aforementioned Embodiment 1.

Further, the substrate 10 may be either a flat substrate or a curved substrate. The curved substrate may be such that, in a case where the substrate 10 (slat 2) is cut along a direction vertical to a longitudinal direction of the substrate having a rectangular shape, a cross-section of the substrate 10 is such a curved shape that a center part of the cross-section projects as compared with both end parts of the cross-section.

### [Light-Emitting Section]

The light-emitting section 11 is a part serving as a light source of the illumination device of the present embodiment.

The light-emitting section 11 is such an organic EL element (light-emitting element) that the first electrode 20, a first organic layer 30a, the second electrode 21, a second organic layer 30b, and the third electrode 22 are provided in this order on the substrate 10 described above (see FIG. 14). The first organic layer 30a includes at least an organic light-emitting layer (a first organic light-emitting layer) made from an organic light-emitting material. The second organic layer 30b also includes at least an organic light-emitting layer (a second organic light-emitting layer) made from an organic light-emitting material.

With an arrangement in which a plurality of organic EL elements each having an organic red light-emitting layer, an organic green light-emitting layer, and an organic blue light-emitting layer are arranged, the light-emitting section 11 can emit light in full color. Further, white light can be emitted by employing (i) an organic EL element in which an organic yellow light-emitting layer and the organic blue light-emitting layer are stacked with each other, or (ii) an organic EL element in which the organic red light-emitting layer, the organic green light-emitting layer, and the organic blue light-emitting layer are stacked with each other.

Note that, in addition to the first electrode 20, the first organic layer 30a, the second electrode 21, the second organic layer 30b, and the third electrode 22, it is possible to provide (i) an insulating edge cover for preventing a leakage at an edge part of the first electrode 20 and (ii) an insulating partition layer for retaining a functional material solution, which is applied in a wet process for forming the first organic layer 30a and the second organic layer 30b (the insulating edge cover and the insulating partition layer are not illustrated in FIG. 14). In this case, the insulating edge cover and the insulating partition layer are provided on the first electrode 20 in this order, and then the first organic layer 30a, the second electrode 21, the second organic layer 30b, and the third electrode 22 are provided on these in this order.

First Organic Layer and Second Organic Layer

The first organic layer 30a and the second organic layer 30b, illustrated in FIG. 14, can have either a single layer structure constituted by a single organic light-emitting layer, or a multilayer structure constituted by an organic light-emitting layer and an electron transport layer. Specifically, examples of both the organic layer 30a and the second organic layer 30b encompass the following 1) through 9).

1) Organic light-emitting layer
2) Hole-transport layer/organic light-emitting layer
3) Organic light-emitting layer/electron-transport layer
4) Hole-transport layer/organic light-emitting layer/electron-transport layer
5) Hole-injection layer/hole-transport layer/organic light-emitting layer/electron-transport layer
6) Hole-injection layer/hole-transport layer/organic light-emitting layer/electron-transport layer/electron-injection layer
7) Hole-injection layer/hole-transport layer/organic light-emitting layer/hole-blocking layer/electron-transport layer
8) Hole-injection layer/hole-transport layer/organic light-emitting layer/hole-blocking layer/electron-transport layer/electron-injection layer
9) Hole-injection layer/hole-transport layer/electron-blocking layer/organic light-emitting layer/hole-blocking layer/electron-transport layer/electron-injection layer

Note, however, that the present invention is not limited to these. Further, each of these layers, namely, the organic light-emitting layer, the hole-injection layer, the hole-transport layer, the hole-blocking layer, the electron-blocking layer, the electron-transport layer, and the electron-injection layer, can have either a single layer structure or a multilayer structure.

Here, in FIG. 14, the above 8) structure is employed. A hole-injection layer 31, a hole-transport layer 32, an organic light-emitting layer 33, a hole-blocking layer 34, an electron-transport layer 35, and an electron-injection layer 36 are provided in this order from the first electrode 20 to the second electrode 21, so as to constitute the organic layer 30a. Further, an electron-injection layer 36′, an electron-transport layer 35′, a hole-blocking layer 34′, an organic light-emitting layer 33′, a hole-transport layer 32′, and a hole-injection layer 31′ are provided from the second electrode 21 to the third electrode 22, so as to constitute the second organic layer 30b.

Note that the first organic layer 30a and the second organic layer 30b do not necessarily have the same structure.

Both the organic light-emitting layers 33 and 33′ can be made from only any one of the following organic light-emitting materials, or made from a combination of a light-emitting dopant and a host material. Further, both the organic light-emitting layers 33 and 33′ can contain, if necessary, a hole-transport material, an electron-transport material, an additive (a donor, an acceptor, etc.), and/or the like, and can have an arrangement in which the material(s) is dispersed in a polymer material (a binding resin) or in an inorganic material. In view of light-emitting efficiency and a lifetime, it is preferable to employ such a material that a light-emitting dopant is dispersed in a host material.

Examples of the organic light-emitting material are identical with those of the aforementioned Embodiment 1.

Examples of a low-molecular organic light-emitting material are identical with those of the aforementioned Embodiment 1.

Examples of a polymer light-emitting material are identical with those of the aforementioned Embodiment 1.

The light-emitting dopant, which is, if necessary, contained in the organic light-emitting layers 33 and 33′, may be a known dopant material for organic EL. Examples of such a dopant material encompass a fluorescent light-emitting material (such as a styryl derivative, perylene, an iridium complex, a coumarin derivative, Lumogen F Red, dicyanomethylene pyran, phenoxazine, and a porphyrin derivative), and a phosphorescent light-emitting organic metal complex (such as bis [(4,6-difluorophenyl)-pyridinato-N,C2′]picolinate iridium (III) (FIrpic), tris(2-phenyl pyridyl)iridium (III) (Ir(ppy)₃), and tris(1-phenylisoquinoline) iridium (III) (Ir(piq)₃)).

Further, examples of the host material which is used with the dopant are identical with those of the aforementioned Embodiment 1.

Furthermore, in order to carry out injection of an electric charge (a hole, an electron) from an electrode and transport (injection) of the electric charge to the organic light-emitting layer efficiently, the charge-injection/transport layer is classified into a charge-injection layer (the hole-injection layers 31 and 31′, and the electron-injection layers 36 and 36′) and a charge-transport layer (the hole-transport layers 32 and 32′, and the electron-transport layers 35 and 35′). The charge-injection/transport layer may be made from only any one of the following charge-injection/transport materials. Further, the charge-injection/transport layer may contain, if necessary, an additive (a donor, an acceptor, etc.) or the like. Furthermore, the charge-injection/transport layer can have an arrangement in which the material(s) is dispersed in a polymer material (a binding resin) or in an inorganic material.

Examples of the electron-injection/transport material are identical with those of the aforementioned Embodiment 1.

Examples of the hole-injection/transport material are identical with those of the aforementioned Embodiment 1.

Furthermore, in order to carry out injection/transport of a hole from an anode, it is preferable that (i) the hole-injection layer is made from a material having a lower energy level of a highest occupied molecular orbital (HOMO) than that of the hole-injection/transport material of the hole-transport layer, and (ii) the hole-transport layer is made from a higher mobility of a hole than that of the hole-injection/transport material of the hole-injection layer.

Further, in order to improve properties of the injection/transport of a hole, it is preferable that the hole-injection/transport material is doped with an acceptor. The acceptor may be a known acceptor material for organic EL. Specific compounds of these are described below as examples. Note, however, that the present invention is not limited to these materials.

Examples of the acceptor are identical with those of the aforementioned Embodiment 1.

Examples of the electron-injection/transport material are identical with those of the aforementioned Embodiment 1.

In order to carry out the injection/transport of an electron from a cathode efficiently, it is preferable that (i) the electron-injection layers 36 and 36′ are made from a material having a higher energy level of a lowest unoccupied molecular orbital (LUMO) than that of the electron-injection/transport material of the electron-transport layers 35 and 35′, and (ii) the electron-transport layers 35 and 35′ are made from a material having a higher mobility of an electron than that of the electron-injection/transport material of the electron-injection layers 36 and 36′.

Moreover, in order to further improve properties of the injection/transport of an electron, it is preferable that the electron-injection/transport material is doped with a donor. The donor may be made from a known donor material for organic EL. Specific compounds of these are described below as examples. Note, however, that the present invention is not limited to these materials.

Examples of the donor material are identical with those of the aforementioned Embodiment 1.

The first organic layer 30a (constituted by the hole-injection layer 31, the hole-transport layer 32, the organic light-emitting layer 33, the hole-blocking layer 34, the electron-transport layer 35, and the electron-injection layer 36) and the second organic layer 30b (constituted by the hole-injection layer 31′, the hole-transport layer 32′, the organic light-emitting layer 33′, the hole-blocking layer 34′, the electron-transport layer 35′, and the electron-injection layer 36′) can be formed by a known wet process by use of solutions for forming an organic layer, in each of which a corresponding one of the aforementioned materials is dissolved and dispersed in a solvent. Examples of the known wet process encompass a coating method (such as the spin coat method, a dipping method, a doctor blade method, a discharge coat method, and a spray coat method), and a printing method (such as an ink-jet method, a relievo printing method, an intaglio printing method, a screen printing method, and a micro gravure coat method). The first organic layer 30a and the second organic layer 30b can be also formed, by use of the aforementioned materials, by a dry process (such as a resistance heating vapor-deposition method, an electron-beam (EB) vapor-deposition method, a molecular beam epitaxy (MBE) method, a sputtering method, and an organic vapor-phase deposition (OVPD) method), a laser transfer method, or the like. In a case where the first organic layer 30a and the second organic layer 30b are formed by the wet process, the solution for forming the organic layer 30 may contain an additive (such as a leveling agent and a viscosity adjusting agent) for adjusting a physicality of the solution.

Generally, both the first organic layer 30a and the second organic layer 30b have a film thickness in a range of 1 nm to 1000 nm. It is preferable that both the first organic layer 30a and the second organic layer 30b have a film thickness in a range of 10 nm to 200 nm. In a case where the first organic layer 30a and the second organic layer 30b have a film thickness of less than 10 nm, it is difficult to realize originally-desired physicalities (an electron injection characteristic, an electron transport characteristic, and an electron confinement property). Further, there is a risk that a pixel might have a defect due to a foreign substance such as dust. Meanwhile, in a case where both the first organic layer 30a and the second organic layer 30b have a film thickness of more than 200 nm, there is an increase in driving voltage due to a resistance component of the first organic layer 30a and the second organic layer 30b. The increase in driving voltage leads to an increase in power consumption.

First Electrode, Second Electrode, and Third Electrode

The first electrode 20, the second electrode 21, and the third electrode 22 serve as a pair of electrodes, namely, an anode and a cathode of the organic EL element. That is, in a case where the first electrode 20 serves as the anode, the second electrode 21 serves as the cathode and the third electrode 22 serves as the anode. In a case where the first electrode 20 serves as the cathode, the second electrode 21 serves as the anode and the third electrode 22 serves as the cathode. The following description deals with specific compounds used as the first electrode 20, the second electrode 21, and the third electrode 22, and specific methods for forming the first electrode 20, the second electrode 21, and the third electrode 22. Note, however, that the present invention is not limited to these materials and methods.

As an electrode material of the first electrode 20, the second electrode 21, and the third electrode 22, a known electrode material can be used. In view of efficiency in carrying out the injection of a hole into the organic light-emitting layers 33 and 33′, examples of a material of the anode (transparent electrode) encompass a metal having a work function of not less than 4.5 eV (such as gold (Au), platinum (Pt), and nickel (Ni)), an oxide (ITO) which has a work function of not less than 4.5 eV and is made of indium (In) and tin (Sn), an oxide (SnO₂) of tin (Sn), which has a work function of not less than 4.5 eV, and an oxide (IZO) which has a work function of not less than 4.5 eV and is made of indium (In) and zinc (Zn). Further, in view of efficiency in carrying out the injection of an electron into the organic light-emitting layers 33 and 33′, examples of an electrode material of the cathode encompass a metal having a work function of not more than 4.5 eV (such as lithium (Li), calcium (Ca), cerium (Ce), barium (Ba), and aluminum (Al)), an Mg:Ag alloy which has a work function of not less than 4.5 eV and contains at least one of the metals, and an Li:Al alloy which has a work function of not less than 4.5 eV and contains at least one of the metals.

The first electrode 20, the second electrode 21, and the third electrode 22 can be formed, by use of at least one of the materials described above, by a known method such as an EB vapor-deposition method, a sputtering method, an ion plating method, and a resistance heating vapor-deposition method. Note, however, that the present invention is not limited to these methods. Further, it is possible to develop, if necessary, a pattern of the electrode thus formed by use of a photolithography method and a laser abrasion method. It is also possible to form directly, by combination of the pattern and the shadow mask, the electrode whose pattern has been developed. It is preferable that each of the electrodes has a film thickness of not less than 50 nm. In a case where the film thickness of any of the electrodes is less than 50 nm, there is a risk that the driving voltage might be increased.

One of the features of the present invention is emitting light from both surfaces of the slat 2. Accordingly, in order to take out the light emitted from the organic light-emitting layer 33′ on a front side of the slat 2 (the upper side in FIG. 12), it is necessary for the third electrode 22 to be made from a transparent material or a translucent material. Further, in order to take out the light emitted from the organic light-emitting layer 33 from the back surface side of the slat 2 (the lower side in FIG. 12), it is necessary for the first electrode 20 to be made from a transparent material or a translucent material, as well.

It is particularly preferable to employ ITO or IZO, as the transparent material. It is preferable that a film thickness of the transparent electrode is in a range of 50 nm to 500 nm, more preferably in a range of 100 nm to 300 nm. In a case where the film thickness of the transparent electrode is less than 50 nm, there is a risk that that a driving voltage might be increased. Furthermore, in a case where the film thickness of the transparent electrode is more than 500 nm, there is a reduction in transmittance of light. This might cause a reduction in luminance.

Further, in view of improvement of color purity and improvement of light-emitting efficiency, there is a case where a microcavity (interference) effect is employed. In such a case, if the light emitted from the organic light-emitting layers 33 and 33′ is taken out from both the first electrode 20 side and the third electrode 22 side, it is preferable that the first electrode 20, the second electrode 21, and the third electrode 22 are translucent electrodes. The translucent electrode may be a single metal translucent electrode or a combination of a metal translucent electrode and a material of a transparent electrode. In view of reflectivity and transmittance, it is preferable that the translucent electrode is made from silver. Further, it is preferable that a film thickness of the translucent electrode is in a range of 5 nm to 30 nm. In a case where the film thickness of the translucent electrode is less than 5 nm, reflection of light is insufficient, and therefore the interference effect cannot be achieved sufficiently. Further, in a case where the film thickness of the translucent electrode is more than 30 nm, the transmittance of light is significantly reduced. This reduction in transmittance of light might cause a reduction in luminance and a reduction in light-emitting efficiency.

On the other hand, in a case where (i) the light emitted from the organic light-emitting layer 30a of the first organic layer 30a is taken out on the first electrode 20 side and (ii) the light emitted from the organic light-emitting layer 33′ of the second organic layer 30b is taken out on the third electrode 22 side, it is preferable that an electrode which does not transmit light is used as the second electrode 21. With such a second electrode 21, it is possible to prevent the light emitted from the organic light-emitting layer 33 of the first organic layer 30a and the light emitted from the organic light-emitting layer of the second organic layer 30b from interfering each other. Examples of the electrode which does not transmit light encompass (i) a black electrode (such as tantalum and carbon), (ii) a reflective metal electrode (such as aluminum, silver, gold, an aluminum-lithium alloy, an aluminum-neodymium alloy, and an aluminum-silicon alloy), and (iii) such an electrode that a transparent electrode and the reflective metal electrode (reflective electrode) are combined with each other.

Edge Cover

It is possible to provide an edge cover at an edge part of the first electrode 20 in order to prevent a leakage of a current between the first electrode 20 and the second electrode 21. Similarly, it is possible to provide an edge cover at an edge part of the second electrode 21 in order to prevent a leakage of a current between the second electrode 21 and the third electrode 22. Since the edge cover provided at the edge part of the second electrode 21 is the same as the edge cover provided at the edge part of the first electrode 20, explanation of the edge cover provided at the edge part of the second electrode 22 is omitted here.

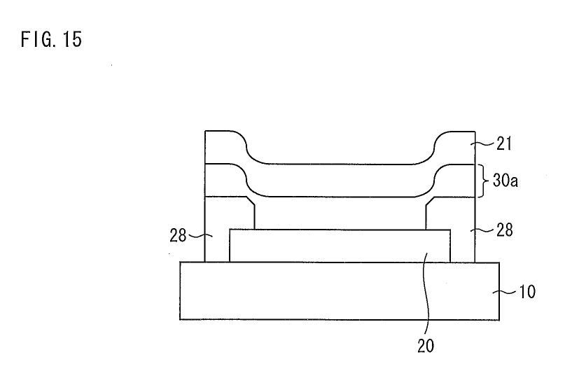

FIG. 15 is a cross-sectional view illustrating an arrangement of a cross-section in a case of the edge cover is provided. The edge cover 28 is provided at the edge part of the first electrode 20 (see FIG. 15). In a case where the edge cover is not provided, a thickness of the first organic layer 30a becomes small, and, as a result, a leakage of a current might occur between the first electrode 20 and the second electrode 21. The provision of the edge cover 28 can prevent such a leakage effectively.

The edge cover can be formed, by use of an insulating material, by a known method such as an EB vapor-deposition method, a sputtering method, an ion plating method, and a resistance heating vapor-deposition method. A pattern of the edge cover can be developed by a photolithography method of a known dry or wet process. Note, however, that the present invention is not limited to these methods.

As the insulating material, a known material can be used. According to the present invention, the insulating material is not particularly limited, as long as the insulating material transmits light. Examples of the insulating material encompass SiO, SiON, SiN, SiOC, SiC, HfSiON, ZrO, HfO, and LaO.

Further, it is preferable that the edge cover has a film thickness in a range of 100 nm to 2000 nm. In a case where the edge cover has a film thickness of not more than 100 nm, an insulating property becomes insufficient. In this case, a leakage might occur between the first electrode and the second electrode, and the leakage might cause an increase in power consumption and such a defect that no light is emitted. Meanwhile, in a case where the edge cover has a thickness of not less than 2000 nm, a film forming process requires a longer time period. This reduces production efficiency and also causes such a defect that a conductive wire of the second electrode 21 is broken at the edge cover.

Sealing Section

In order to carry out sealing further on an outermost surface (third electrode 22), it is possible to provide, on the third electrode 22 via an inorganic film or a resin film, the sealing section 12 (a sealing substrate or a sealing film) made from plastic or the like.

Examples of a method for forming the sealing substrate and the sealing film are identical with those of the aforementioned Embodiment 1. Note, however, that, in order to take out the light emitted from the second organic layer 30b on the third electrode 22 side, that is, the light emitted from the second organic layer 30b is taken out on the front side of the slat 2, it is necessary that both the sealing film and the sealing substrate are made from a transparent material.

Note that the sealing substrate is not necessarily employed, and the sealing can be carried out by use of only an inorganic film and a resin film.

### (2) Conductive Wire Group

The conductive wire group 3 illustrated in FIG. 12 is connected to the power supply device provided in the head box 7 (described later), and, for each of the plurality of slats 2 arranged in parallel with each other, supplies a voltage to the terminal 15 of the first electrode 20, the terminal 14 of the second electrode 21, and the terminal 17 of the third electrode 22 (see FIG. 13).

Specifically, the conductive wire group 3 is constituted by a first conductive wire group 3a including two conductive wires and a second conductive wire group 3b including two conductive wires.

The first conductive wire group 3a is provided to control the light-emitting of the first organic layer 30a of each of the plurality of slats 2, and includes a first conductive wire for the first organic layer (first conductive wire) and a second conductive wire for the first organic layer (second conductive wire). The first conductive wire for the first organic layer is connected to the terminal 15 of the first electrode 20, which terminal 15 is provided in the vicinity of one of short sides of each of the plurality of slats 2. The second conductive wire for the first organic layer is connected to the terminal 14 of the second electrode 21, which terminal 14 is provided in the vicinity of one of long sides of each of the plurality of slats 2.

Meanwhile, the second conductive wire group 3b is provided to control the light-emitting of the second organic layer 30b of each of the plurality of slats 2, and includes a first conductive wire for the second organic layer (fourth conductive wire) and a second conductive wire for the second organic layer (third conductive wire). The first conductive wire for the second organic layer is connected to the terminal 17 of the third electrode 22, which terminal 17 is provided in the vicinity of the other one of short sides of each of the plurality of slats 2. The second conductive wire for the second organic layer is connected to the terminal 14 of the second electrode 21, which terminal 14 is provided in the vicinity of the one of long sides of each of the plurality of slats 2.

The two wires of the first conductive wire group 3a and the two wires of the second conductive wire group 3b are not particularly limited and can be made from a known material, as long as these can transmit an input signal received from the power supply device provided in the head box 7. For examples these wires can be made from copper, silver, gold, or aluminum. Further, examples of the material of these wires encompass not only inorganic materials but also organic materials.

In the above description, in order to control independently the light-emitting of the first organic layer 30a and the light-emitting of the second organic layer 30b, the conductive wires for the respective organic layers (the first organic layer 30a, the second organic layer 30b) are connected to the second electrode 21. However, the present invention is not limited to this. It is possible to have such an arrangement that (i) only a single conductive wire is connected to the second electrode 21, (ii) an input signal is transmitted to (I) the single conductive wire and (II) the first conductive wire for the first organic layer or the first conductive wire for the second organic layer, and therefore (iii) the light-emitting of the first organic layer 30a and the light-emitting of the second organic layer 30b are independently controlled.

### (3) Support Wire

The support wire 4 here is the same as a support wire of the aforementioned Embodiment 1, and therefore explanation of the support wire 4 is omitted here for the sake of simple explanation.

(4) Slat pressure member

The slat pressure member 5 is provided adjacent to each of the plurality of slats 2 in the vicinity of one of surfaces of each of the plurality of slats 2, which one of surfaces is on a substrate 10 side, specifically, in a position adjacent to a central axis part of the slat 2 in a longitudinal direction of the slat 2 (see FIG. 12). More specifically, the slat pressure member 5 is provided between the one of surfaces of the slat 2, on the substrate 10 side, and the first support wire 4a extending across the one of surfaces of the slat 2, on the substrate 10 side.

It is preferable that a length of the slat pressure member 5 in a direction of the short sides of the slats 2 is in a range of 1/10 to ½ of that of each of the short sides of the slat 2. With the slat pressure member 5 having such a length, it becomes possible to cause each of the plurality of slats 2 to be bent. In a case where the length of the slat pressure member 5 is less than 1/10 of the length of each of the short sides, the slat pressure member cannot give sufficient pressure to the slat 2. Meanwhile, in a case where the length of the slat pressure member 5 is more than ½ of the length of each of the short sides, the slat pressure member 5 cannot give pressure to only a central part of the slat 2, and therefore there is a risk that it might be difficult to bend the slat 2.

The slat pressure member 5 is fixed to the first support wire 4a. However, the present invention is not limited to this. The slat pressure member 5 may be fixed to the one of surfaces of the slat 2, on the substrate 10 side. Alternatively, the slat pressure member 5 may be fixed to both (i) the first support wire 4a and (ii) the one of surfaces of the slat 2, on the substrate 10 side.

According to the present embodiment, the light is emitted in an upper-lower direction from the light-emitting section 11 while the light-emitting surface of the slat 2 is horizontally placed. With the arrangement, in a case where (i) the second support wire 4b moves in the upper-lower direction, and as a result, (ii) the slat 2 is inclined, the slat pressure member 5 presses the one of surfaces of the slat 2 from a position in the vicinity of the one of surfaces toward the other one of surfaces by use of tensile force of the first support wire 4a. A mechanism for causing the slat 2 to be bent is thus realized.

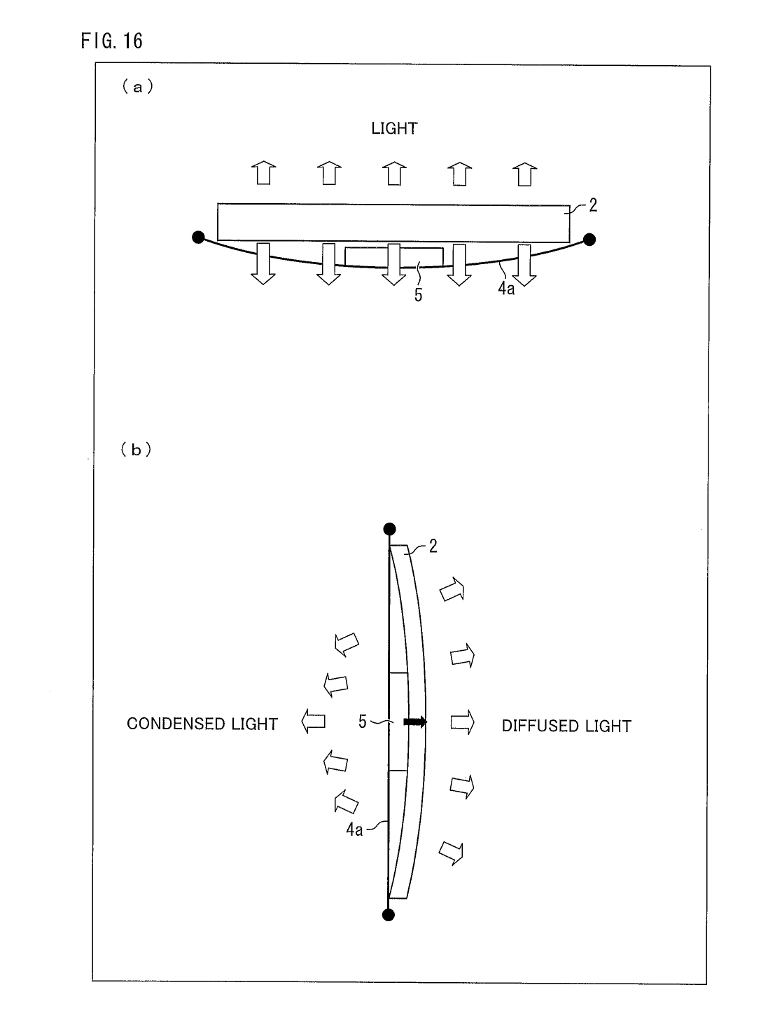

(a) and (b) of FIG. 16 illustrates such a pressure mechanism. (a) of FIG. 16 is a cross-sectional view illustrating a relationship between (i) the slat 2 whose light-emitting surface is substantially parallel to a horizontal direction, (ii) the slat pressure member 5, and (iii) the first support wire 4a. (b) of FIG. 16 is a cross-sectional view illustrating a relationship between (i) the slat 2 whose light-emitting surface is substantially parallel to a vertical direction, (ii) the slat pressure member 5, and (iii) the first support wire 4a.

In the state of (a) of FIG. 16, the first support wire 4a is bent. That is, the slat pressure member 5 is not giving pressure to the slat 2.

On the other hand, in the state of (b) of FIG. 16, the first support wire 4a is stretched. In this case, the slat pressure member 5 is pressed toward the slat 2 by tensile force of the first support wire 4a. As a result, the slat pressure member 5 gives pressure to the slat 2.

The slat 2 receiving pressure from the slat pressure member 5 projects toward a region opposite to the position of the slat pressure member 5. That is, only the central axis part of the slat 2 projects in a direction in which the slat 2 is pressed. As a result, the slat 2 is bent as illustrated in (b) of FIG. 16. This causes (i) the light emitted from the side opposite to a slat pressure member 5 side to be diffused, as compared with the light emitted from the slat 2 in a flat state illustrated in (a) of FIG. 16, and (ii) the light emitted from the slat pressure member 5 side to be condensed, as compared with the light emitted from the slat 2 in the flat state.

Since the slat 2 of the present embodiment emits light from both (i) the slat pressure member 5 side and (ii) the side opposite to the slat pressure member side, it is necessary for the slat pressure member 5 to be made from a material having optical transparency. Such a material is not particularly limited to an organic material or an inorganic material, as long as the material has optical transparency and can give pressure to the slat 2. However, it is preferable that the slat pressure member 5 is made from a plastic material such as polyethylene and polypropylene. Further, a shape of the slat pressure member 5 is not particularly limited, as long as the slat pressure member 5 is attached to the support wire 4.

As described above, with the arrangement employing the slat pressure member 5, it is possible to cause the slat 2 having flexibility to be bent in accordance with rotational movement in forward and backward. That is, it is possible to cause the shape of the slat 2 to have a desired curvature radius reversibly. By causing the slat 2 to have a desired curvature radius reversibly, it is possible to cause the light emitted from the light-emitting element of the slat 2 to be diffused or condensed.

In the present embodiment, the shape of the slat pressure member 5 is a rectangular solid shape. Note, however, that the shape of the slat pressure member 5 is not limited to this, and various shapes described in the aforementioned Embodiment 1 can be applied.

### (5) Up-and-Down Code

The up-and-down code 6 here is the same as a support wire 4 of the aforementioned Embodiment 1, and therefore explanation of the up-and-down code 6 is omitted here for the sake of simple explanation.

(6) Head Box in which Power Supply Device is Provided

The head box 7 here is the same as the support wire 4 of the aforementioned Embodiment 1, and therefore explanation of the head box 7 is omitted here for the sake of simple explanation.

Note that the light-emitting section 11 can be subjected to active matrix driving.

### (Operation of Illumination Device)

Next, a method of adjusting an inclined angle of the slat 2 and a method of operating the illumination device 1 are the same as those of the aforementioned Embodiment 1, and therefore explanations of these are omitted here for the sake of simple explanation.

### (Operational Effect of Present Embodiment)

As described above, with the above arrangement, it is possible to realize an illumination device having a large-light emitting region by arranging a plurality of slats 2 in parallel with each other. Accordingly, it is not necessary to employ a single large substrate, and therefore it is possible to achieve easily (i) a reduction in cost and (ii) an increase in a size of a light-emitting region of an illumination device. Further, since an input signal is stably supplied from an external power supply (supply of a current or application of a voltage) to the light-emitting section 11, it is possible to emit light stably all the time, as compared with an illumination device which emits light by use of sunlight.

Further, the slat pressure member 5 is provided on one of surfaces of each of the plurality of slats 2, and gives pressure to the slat 2 toward the other one of the surfaces, opposite to the one of the surfaces, in accordance with rotational movement of the slat 2, caused by the support wire 4. The provision of the slat pressure member 5 makes it possible for the slat 2 having flexibility to be bent in accordance with the movement forward and backward. That is, it is possible to cause the shape of the slat 2 to have a desired curvature radius reversibly.

By causing the slat 2 to have a desired curvature radius reversibly, as described above, it is possible to cause the light emitted from the light-emitting section 11 of the slat 2 to be diffused or condensed. Accordingly, it is possible to provide the illumination device 1 which can meet any lighting purposes.

Furthermore, according to the arrangement, each of the plurality of slats 2 is such that the light is emitted from the light-emitting section 11 is emitted not only from the one of surfaces of the slat 2 but also from the other one of surfaces. In a case where (i) the slat 2 is arranged to emit light only from one of the surfaces, and (ii) a user hopes to carry out switching between a mode for condensing light and a mode for diffusing light, it is necessary for the user to replace the slat 2 itself for condensing light itself with another slat 2 for diffusing light, and vice versa. However, according to the arrangement described above, it is possible to carry out switching between the mode for condensing light and the mode for diffusing light by rotational movement of the slat 2, caused by the support wire 4, without such replacement of the slat 2 with the another slat 2.

In the above description, the light emitted from the organic light-emitting layer 33 of the first organic layer 30a (see FIG. 14) is taken out from the first electrode 20 side, while the light emitted from the organic light-emitting layer 33′ of the second organic layer 30b is taken out from the third electrode 22 side. With the arrangement, the slat pressure member 5 is provided on the first electrode 20 side. Accordingly, the light emitted from the organic light-emitting layer 33 of the first organic layer 30a can be condensed, and the light emitted from the organic light-emitting layer 33′ of the second organic layer 30b (opposite side) can be diffused. Here, it is possible, for example, that (i) a switch is provided in the head box 7 (see FIG. 12), and (ii) a mode for emitting light only on a condensed light side and a mode for emitting light only on a diffused light side can be switched by operating the switch.

By adjusting a size of the slat pressure member 5, it is possible to adjust a range of a desired curvature radius of the slat 2. This makes it possible to carry out fine control of how much the light is diffused or condensed, in accordance with a lighting purpose of the illumination device 1.

### Modified Example of Embodiment 2

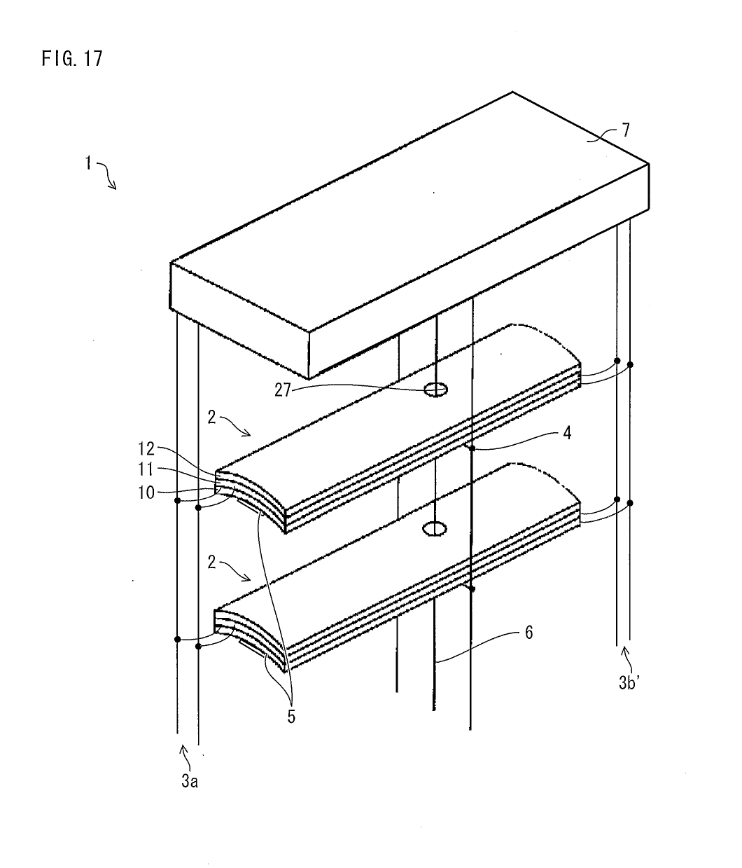

In the aforementioned Embodiment 2, a first conductive wire group 3a and a second conductive wire group 3b are provided together in the vicinity of one of short sides of each of a plurality of slats 2 (see FIG. 12). However, the present invention is not limited to this. For example, it is possible to have an arrangement in which (i) the first conductive wire group 3a is provided in the vicinity of one of short sides of each of the plurality of slats 2, and (ii) a second conductive wire group 3b′ is provided in the vicinity of the other one of short sides of each of the plurality of slats 2 (see FIG. 17). This arrangement is made in view of such positioning that a terminal 15 (see FIG. 13) of a first electrode 20 is provided in the vicinity of the one of short sides of the slat 2, and a terminal 17 (see FIG. 13) of a third electrode 22 is provided in the vicinity of the other one of short sides of the slat 2. In other words, in a case where the first conductive wire group 3a and the second conductive wire group 3b are provided together in the vicinity of the one of short sides of the slat 2, it is necessary to cause a first conductive wire for a second organic layer, included in the second conductive wire group 3b, to be extended to the terminal 17 (see FIG. 13) provided in the vicinity of the other one of short sides of the slat 2. This increases a resistance of the first conductive wire. Meanwhile, with the arrangement of the present modified example, there would not be such extension of the first conductive wire.

Further, in the present modified example, the first conductive wire group 3a and the second conductive wire group 3b are provided to be away from each other. That is, in a case where the first conductive wire group 3a and the second conductive wire group 3b are provided to be close to each other, there is a case where it is necessary to carry out a process for coating these conductive wire groups with an insulating material so that these conductive wires would not be in contact with each other. According to the arrangement of the present modified example, it is not necessary to carry out such a process. It is therefore possible to prevent an increase in cost and an increase in resistance of conductive wires.

### Embodiment 3

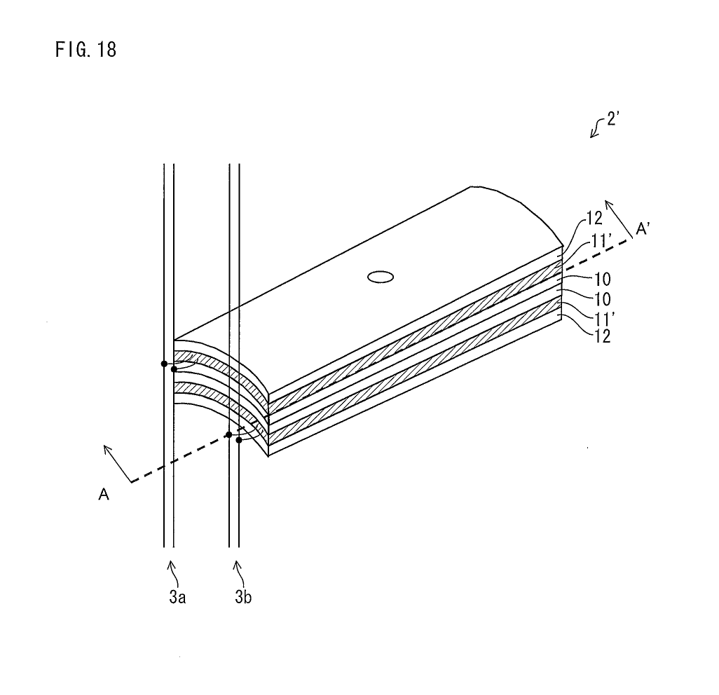

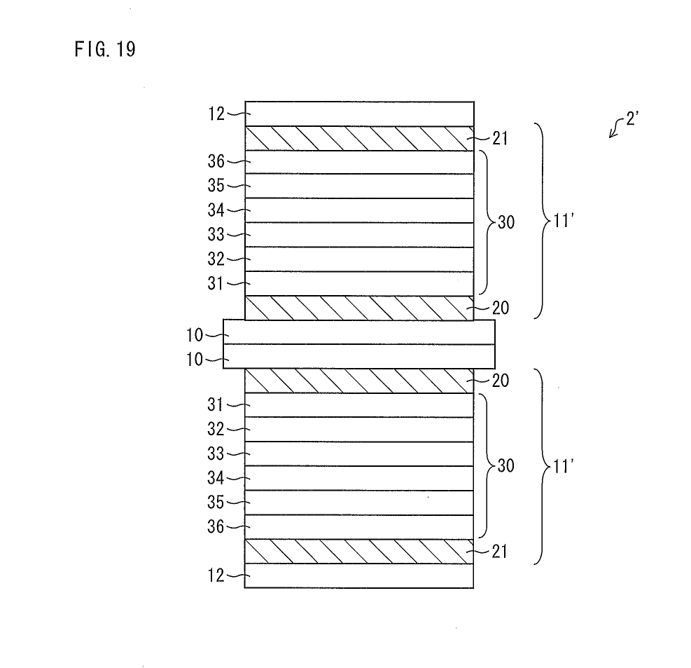

Another embodiment of an illumination device of the present invention is described below with reference to FIGS. 18 and 19. Note that, for the sake of simple explanation, members having the same functions as those of members described in the aforementioned Embodiments have the same reference signs as those of the members described in the aforementioned Embodiments, and explanations of these are omitted here.

In the aforementioned Embodiment 2, each of a plurality of slats 2 has a multilayer arrangement in which a light-emitting section 11 and a sealing section 12 are stacked with each other (see FIG. 12). The light-emitting section 11 is such that a first electrode 20, a first organic layer 30a, a second electrode 21, a second organic layer 30b, and a third electrode 22 are provided on a substrate 10 in this order. Meanwhile, the present embodiment is different from Embodiment 2 in multilayer arrangement of the slat 2.

More specifically, a slat 2′ of the present embodiment has an arrangement in which (i) two substrates 10 are attached to each other so as to serve as an intermediate layer in combination with each other, and (ii) a light-emitting section 11 and a sealing section 12 are provided on each of the two substrates 10 (see FIG. 18). That is, the sealing section 12, the light-emitting section 11′, the substrate 10, another substrate 10, another light-emitting section 11′, and another sealing section 12 are provided in this order from a front surface of the slat 2′ to a back surface of the slat 2′.

Details of arrangements of the substrate 10 and the sealing section 12 of the slat 2′ of the present embodiment are the same as those of arrangements of a substrate 10 and a sealing section 12 of the aforementioned Embodiment 1.

Meanwhile, both the light-emitting section 11′ and the another light-emitting section 11′ are such that a first electrode 20, an organic layer 30, and a second electrode 21 are provided in this order from the substrate 10 (another substrate 10) to the sealing section 12 (another sealing section 12) (see FIG. 19). The organic layer 30 is such that a hole-injection layer 31, a hole-transport layer 32, an organic light-emitting layer 33, a hole-blocking layer 34, an electron-transport layer 35, and an electron-injection layer 36 are provided in this order from the first electrode 20 to the second electrode 21. Details of the first electrode 20 and the second electrode 21 are the same as those of a first electrode 20 and a second electrode 21 of the aforementioned Embodiment 1. Further, details of the layers constituting the organic layer 30 are the same as those of a hole-injection layer 31, a hole-transport layer 32, an organic light-emitting layer 33, a hole-blocking layer 34, an electron-transport layer 35, and an electron-injection layer 36 of the aforementioned Embodiment 1.

Further, although no edge cover is illustrated in FIG. 19, it is possible to provide an edge cover as in the aforementioned Embodiment 2.

### (Operational Effect of the Present Embodiment)

In Embodiment 2, the light-emitting section 11 is a single layer (see FIG. 12). However, the single layer is constituted by a large number of the organic layers (15 layers including electrodes). This causes a risk of a reduction in yield. On the other hand, according to the present embodiment, the light-emitting section 11′ is divided into two layers, and each of the two layers are constituted by 8 layers (including electrodes). That is, the number of the organic layers constituting the light-emitting section is relatively small, and therefore, this arrangement has no risk of a reduction in yield.

That is, according to the present embodiment, the 8 layers are provided on one of the substrates 10, and another 8 layers are also provided on the other one of substrates 10. Lastly, the one of substrates 10 and the other one of substrates 10 are attached to each other, so as to provide the light-emitting sections 11′. A process for providing the 8 layers on the one of substrates 10 and a process for providing the another 8 layers on the other one of substrates 10 can be carried out simultaneously. Accordingly, as compared with a case where the 15 layers are continuously provided, it is possible to suppress a reduction in yield.

In the present embodiment, the substrate is divided into tow layers so as to suppress a reduction in yield. Note, however, that, as a matter of course, even if the substrate serving as an intermediate layer is provided as a single substrate, it is possible to achieve features of the present invention, that is, (i) light can be emitted from both surfaces, and (ii) switching can be carried out between a mode for diffusing light and a mode for condensing light. The arrangement in which the substrate serving as an intermediate layer is a single substrate is encompassed in the scope of the present invention.

### Modified Example 1 of Embodiment 3

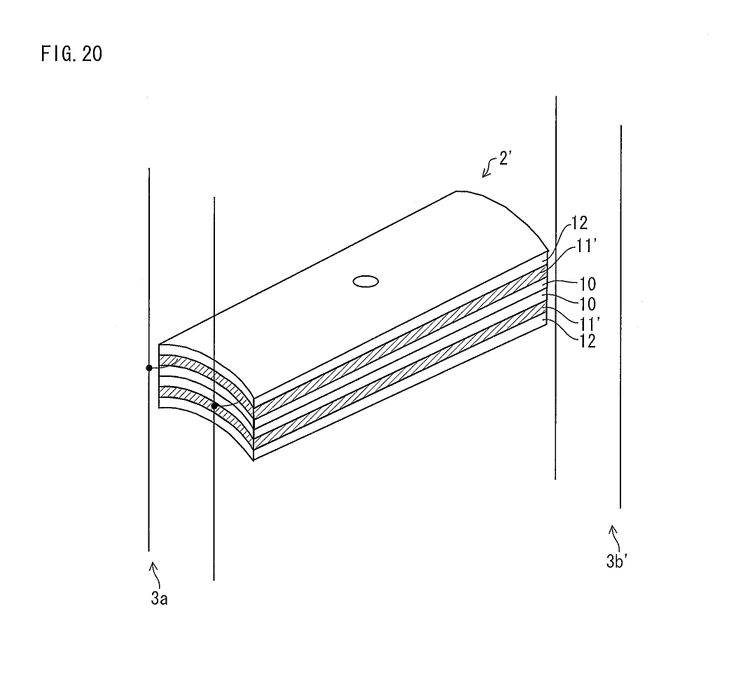

In the aforementioned Embodiment 3, a first conductive wire group 3a and a second conductive wire group 3b are provided together in the vicinity of one of short sides of each of a plurality of slats 2 (see FIG. 18). Note, however, that the present invention is not limited to this. For example, it is possible to provide (i) a first conductive wire group 3a in the vicinity of one of short sides of each of the plurality of slats 2 and (ii) a second conductive wire group 3b′ in the vicinity of the other one of short sides of each of the plurality of slats 2 (see FIG. 20).

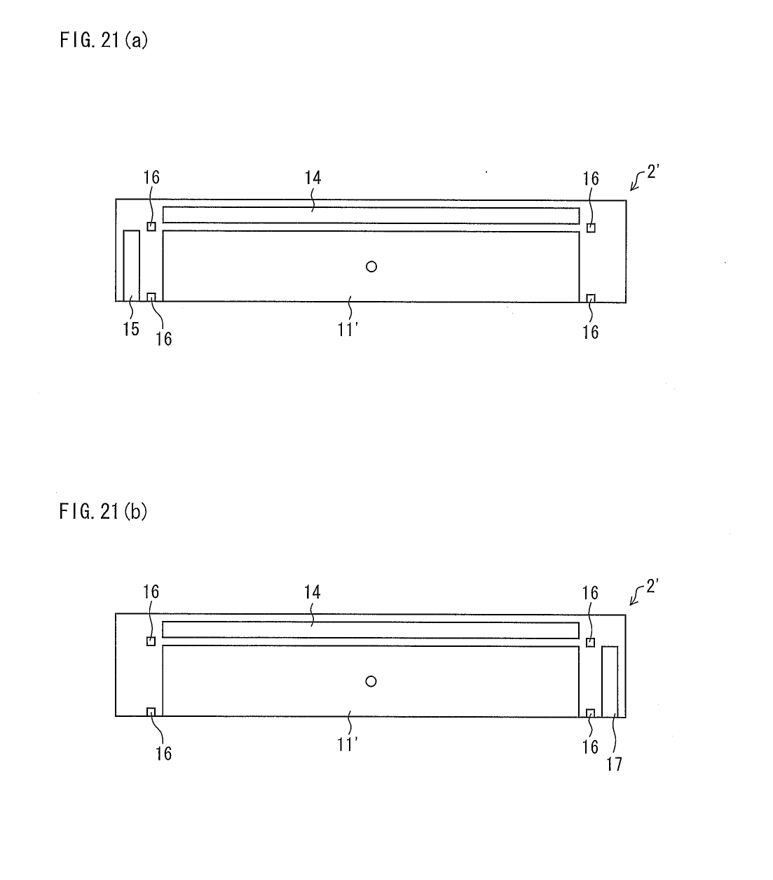

In the present modified example, (i) on a surface of one of one of substrates 10, on which surface a light-emitting section 11′ is provided, a terminal 15 of a first electrode 20 is provided in the vicinity of one of short sides of each of the plurality of slats 2, and a terminal 14 of a second electrode 21 is provided in the vicinity of the other one of short sides of each of the plurality of slats 2 (see (a) of FIG. 21), and (ii) on a surface of the other one of substrates 10, on which surface another light-emitting section 11′ is provided, a terminal 17 of another first electrode 20 is provided in the vicinity of the other one of short sides of each of the plurality of slats 2, and a terminal 14 of the second electrode 21 is provided on the one of short sides of each of the plurality of slats 2 (see (b) of FIG. 21). Note here that the terminal 15 provided on the one of the substrates 10 is placed in the vicinity of the one of short sides of the slat 2, while the terminal 17 provided on the other one of the substrates 10 is placed in the vicinity of the other one of short sides of the slat 2.

By (i) providing the terminal 15 and the terminal 17 to be opposite to each other in a longitudinal direction of the slat 2 (substrates 10) as described above, and (ii) providing the conductive wire groups in the same manner as the aforementioned arrangement (Modified Example of Embodiment 1), it is possible to prevent an increase in cost and an increase in a resistance of a conductive wire.

### Modified Example 2 of Embodiment 3

The aforementioned Embodiment 3 employs a top-emission structure in which light is taken out from a sealing section 12 of each of two pairs of organic EL sections. However, the present invention is not limited to this. For example, it is possible that (i) the two pairs of organic EL sections are attached to each other in such a manner that not two substrates 10 but a substrate 10 of one of the organic EL elements and a sealing section 12 of the other one of the organic EL elements are attached to each other, and therefore the one of light-emitting sections has the top-emission structure, and the other one of light-emitting sections has a bottom-emission structure. Further, it is also possible that (i) the sealing sections 12 of the light-emitting sections are attached to each other and therefore (ii) both the light-emitting sections have the bottom-emission structure. In a case where a low manufacturing cost has priority, it is advantageous to have two bottom-emission structures by attaching both the sealing sections 12 to each other. This is because, with such an arrangement, it is unnecessary to manufacture the two pairs of organic EL elements having different structures.

Lastly, the following description deals with details of an illumination device in accordance with the present embodiment on the basis of examples, more specifically. Note that the present invention is not limited to any one of the following examples.

### EXAMPLES

### Example 1

### Top-Emission Type Illumination Device of Embodiment 1

A plastic substrate (thickness: 0.2 mm, surface area (single): 500×220 mm²) coated with oxide silicon (thickness: 200 nm) was used as a substrate 10 (see FIG. 2). Note that a through-hole 2′ of the substrate 10, through which an up-and-down code 6 extended, was formed in advance.

On one of surfaces of the plastic substrate (substrate 10), a first electrode (anode) of each pixel was formed by a sputtering method. A first electrode 20 (see FIG. 3) was provided in such a manner that Al (aluminum) (film thickness: 150 nm) and IZO (indium oxide-zinc oxide) (thickness: 20 nm) were laminated.

Next, on the surface (500×220 mm²), patterning was carried out only in a certain area (492×216 mm²) by a photolithography method so that ITO was left. The first electrode 20 (see FIG. 3) was thus formed only in the certain area.

Next, SiO₂ (thickness: 200 nm) was provided by the sputtering method. Then, SiO₂ was patterned by the photolithography method so that only an edge part of the first electrode 20 was covered with SiO₂. An edge cover was thus formed on the edge part of the first electrode 20. In the present example, only a part extending from 4 sides of the first electrode 20 by 10 μm was covered with SiO₂.

After that, the substrate was washed with water, and was subjected to an ultrasonic cleaning process using purified water (for 10 minutes), an ultrasonic cleaning process using acetone (for 10 minutes), and a vapor washing process using isopropyl alcohol (for 5 minutes) in this order. Then, the substrate was dried for 1 hour at 100° C.

Here, a light-emitting section 11 (see FIG. 4) provided on the substrate 10 (500×220 mm²) was designed to have an area of 492×200 mm². Further, around the light-emitting section 11, a sealing area (width: 2 mm) was formed. Furthermore, in the vicinity of one of short sides of the light-emitting section 11 having a rectangular shape, a terminal lead-out area 15 (width: 2 mm) was formed outside the sealing area. Moreover, in the vicinity of one of long sides of the light-emitting section 11, a terminal lead-out section (adjacent surface) (width: 2 mm) was formed.

Next, after the aforementioned processes were carried out, RGB light-emitting pixels were provided on the substrate 10 on which the first electrode 20 was formed. The provision of the RGB light-emitting pixels was carried out by a vapor-deposition method in which a material was applied to only a desired part by use of a shadow mask.

After that, in a desired region, 1,1-bis-di-4-tolylamino-phenyl-cychrohexane (TAPC) was provided as a hole-injection material by the method in which a material was applied to only a desired part by use of a shadow mask. By a resistance heating vapor-deposition method, a hole-injection layer 31 (see FIG. 3) was provided to have (i) a film thickness of 50 nm in a red light-emitting pixel section (ii) a thickness of 150 nm in a green light-emitting pixel section and (iii) a thickness of 100 nm in a blue light-emitting pixel section.

Next, as a hole-transport material, N,N′-Di (1-naphthyl)-N,N′-diphenyl-1,1′-biphenyl-1,1′-biphenyl-4,4′-diamine (NPD) was provided by the resistance heating vapor-deposition method, so that a hole-transport layer 32 (film thickness: 40 nm) was formed (see FIG. 3).

Then, by the method in which a material was applied to only a desired part by use of the shadow mask, an organic red light-emitting layer (thickness: 30 nm) was formed on a desired red light-emitting pixel on the hole-transport layer 32. The red organic light-emitting layer was formed in such a manner that 3-phenyl-4(1′-naphthyl)-5-phenyl-1,2,4-triazole (TAZ) (host material) and bis(2-(2′-benzo[4,5-a]thienyl)pyridinato-N,C3′) iridium (acetylacetonate) (btp₂Ir(acac)) (red phosphorescent light-emitting dopant) were co-deposited at respective vapor-deposition speeds of 1.4 Å/second and 0.15 Å/second.

Next, a green organic light-emitting layer (thickness: 30 nm) was formed on a desired green light-emitting pixel provided on the hole-transport layer 32 by the method in which a material was applied to a desired part by use of a shadow mask. The green organic light-emitting layer was formed in such a manner that TAZ (host material), and tris (2-phenylpyridine) iridium (III) (Ir(ppy)₃) (green phosphorescent light-emitting dopant) were co-deposited at respective vapor-deposition speeds of 1.5 Å/second and 0.2 Å/second.

Then, a blue organic light-emitting layer (thickness: 30 nm) was formed on a desired blue light-emitting pixel on the hole-transport layer 32 by the method in which a material was applied to only a desired part by use of a shadow mask. The green organic light-emitting layer was formed in such a manner that 1,4-bis-triphenylsilyl-benzene (UGH-2) (host material) and bis[(4,6-difluorophenyl)-pyridinato-N,C2′]picolinate iridium (III) (FIrpic) (blue phosphorescent light-emitting dopant) were co-deposited at respective vapor-deposition speeds of 1.5 Å/second and 0.2 Å/second.

Next, a hole-blocking layer 34 (see FIG. 3) was formed on an organic light-emitting layer 33 (see FIG. 3) formed by the aforementioned method. The hole-blocking layer 34 had a film thickness of 10 nm and was made from 2,9-dimethyl-4,7-diphenyl-1,10-phenanthroline (BCP).

Then, an electron-transport layer 35 (film thickness: nm), made from tris(8-hydroxyquinoline) aluminum (Alq₃), was formed on the hole-blocking layer 34.

Then, a magnesium-silver (1:9) alloy (film thickness: 19 nm) was formed on a surface of the electron-transport layer 35 by a vacuum vapor-deposition method. The translucent second electrode 21 (see FIG. 3) was thus formed.

Next, on the translucent second electrode 21, a protection layer, which had a film thickness of 100 nm and was made from SiON, was formed, by an ion plating method by use of a shadow mask, in an area extending from the 4 sides of the light-emitting section 11 by 2 mm. Further, on the protection layer, a parylene film having a film thickness of 2 μm was formed by a vapor-deposition polymerization method. The formation of the protection layer (SiON) and the parylene film was carried out 5 times so that a laminate film constituted by 5 layers was formed. The laminate film was used as a sealing section 12. The slat 2 was thus completed.

The present example employs a top-emission structure in which the light emitted from the light-emitting section 11 is taken out from a sealing section 12 side, that is, an upper part of the slat 2 illustrated in FIG. 1 emits light. In view of this, by operating a support wire 4 to rotate in a direction opposite to a direction in which the light was taken out, as illustrated in FIG. 4, a slat pressure member 5 gave pressure provided on the support wire 4 to the slat 2 from a substrate 10 side. The slat pressure member 5 was made from a plastic material whose surface facing the slat 2 had an area of (500×50 mm²) and whose thickness was 3 mm. The slat pressure member 5 was fixed to the support wire 4a. As a result, a shape of the slat 2 became a convex shape as illustrated in (b) of FIG. 9, and therefore a high light diffusion effect could be achieved.

Finally, a plurality of slats 2 thus manufactured were arranged in parallel with each other by use of a support wire 4 (see FIG. 1), so as to constitute a blind. Further, a conductive wire group 3 was provided so as to supply an input signal received from a power supply device 7 (see FIG. 1) provided in a head box to the light-emitting section 11 (supply of a current or application of a voltage). A conductive wire group 6 for controlling light-emitting was connected to (i) a terminal 15 provided one the slat 2 in the vicinity of one of short sides of the slat 2 and (ii) a terminal 14 provided on the slat 2 in the vicinity of one of long sides of the slat 2. A blind-type illumination device in which a slat 2 was used as 1 unit was thus completed.

Note that a curved shape of the slat 2 was realized by (i) using the substrate 10 which was originally curved before each of the layers described above was formed or (ii) causing the substrate 10 to be curved before each of the layers described above was formed.

Here, a desired voltage was applied from the power supply device to a group of electrodes of the illumination device thus completed. As a result, it was confirmed that desired uniform white light could be achieved without any problem.

### Example 2

### Bottom-Emission Type Illumination Device of Embodiment 1

Example 2 is different from the aforementioned Example 1 only in first electrode. In the present Example, a transparent electrode (anode) (film thickness: 300 nm) was formed as a first electrode 20 by providing, on one of surfaces of a plastic substrate 10, indium tin oxide (ITO) by a sputtering method (so that the first electrode 20 had a surface resistance of 10Ω/□).

### Example 3

### Illumination Device Having Arrangement of Embodiment 2

A plastic substrate (thickness: 0.2 mm, surface area (single): 500×220 mm²) coated with oxide silicon (thickness: 200 nm) was used as a substrate 10 (see FIG. 13). Note that a through-hole 27 of the substrate 10, through which an up-and-down code 6 extended, was formed in advance.

On one of surfaces of the plastic substrate (substrate 10), indium tin oxide (ITO) was provided by a sputtering method so that a transparent electrode (anode) (film thickness: 300 nm) was provided as a first electrode 20. The first electrode 20 was provided so as to have a surface resistance of 10Ω/□.

Next, on the surface (500×220 mm²), patterning was carried out only in a certain area (492×216 mm²) by a photolithography method so that an ITO was left. The first electrode 20 (see FIG. 14) was thus formed only in the certain area.

Next, SiO₂ (thickness: 200 nm) was provided by the sputtering method. Then, SiO₂ was patterned by the photolithography method so that only an edge part of the first electrode 20 was covered with SiO₂. An edge cover was thus formed on the edge part of the first electrode 20. In the present example, only a part extending from 4 sides of the first electrode 20 by 10 μm was covered with SiO₂.

After that, the substrate was washed with water, and was subjected to an ultrasonic cleaning process using purified water (for 10 minutes), an ultrasonic cleaning process using acetone (for 10 minutes), and a vapor washing process using isopropyl alcohol (for 5 minutes) in this order. Then, the substrate was dried for 1 hour at 100° C.

Here, a light-emitting section 11 (see FIG. 14) provided on the substrate 10 (500×220 mm²) was designed to have an area of 492×200 mm². Further, around the light-emitting section 11, a sealing area (width: 2 mm) was formed. Further, in the vicinity of one of short sides of the light-emitting section 11 having a rectangular shape, a terminal lead-out area (for terminals 15 and 17) (width: 2 mm) was formed outside the sealing area. Furthermore, in the vicinity of one of long sides of the light-emitting section 11, a terminal lead-out section (for terminal 14) (width: 2 mm) was formed.

Next, after the aforementioned processes were carried out, RGB light-emitting pixels were provided on the substrate 10 on which the first electrode 20 was formed. The provision of the RGB light-emitting pixels was carried out by a vapor-deposition method in which a material was applied to only a desired part by use of a shadow mask.

After that, in a desired region, 1,1-bis-di-4-tolylamino-phenyl-cychrohexane (TAPC) was provided as a hole-injection material by the method in which a material was applied to only a desired part by use of a shadow mask. By a resistance heating vapor-deposition method, a hole-injection layer 31 (see FIG. 14) was provided to have (i) a film thickness of 50 nm in a red light-emitting pixel section (ii) a thickness of 150 nm in a green light-emitting pixel section and (iii) a thickness of 100 nm in a blue light-emitting pixel section.

Next, as a hole-transport material, N,N′-Di(1-naphthyl)-N,N′-diphenyl-1,1′-biphenyl-1,1′-biphenyl-4,4′-diamine (NPD) was provided by the resistance heating vapor-deposition method, so as to form a hole-transport layer 32 (film thickness: 40 nm) (see FIG. 14).

Then, by the method in which a material was applied to only a desired part by use of the shadow mask, an organic red light-emitting layer (thickness: 30 nm) was formed on a desired red light-emitting pixel on the hole-transport layer 32. The red organic light-emitting layer was formed in such a manner that 3-phenyl-4(1′-naphthyl)-5-phenyl-1,2,4-triazole (TAZ) (host material) and bis(2-(2′-benzo[4,5-a]thienyl)pyridinato-N,C3′) iridium (acetylacetonate) (btp₂Ir(acac)) (red phosphorescent light-emitting dopant) were co-deposited at respective vapor-deposition speeds of 1.4 Å/second and 0.15 Å/second.

Next, a green organic light-emitting layer (thickness: 30 nm) was formed on a desired green light-emitting pixel provided on the hole-transport layer 32 by the method in which a material was applied to a desired part by use of a shadow mask. The green organic light-emitting layer was formed in such a manner that TAZ (host material), and tris (2-phenylpyridine) iridium (III) (Ir(ppy)₃) (green phosphorescent light-emitting dopant) were co-deposited at respective vapor-deposition speeds of 1.5 Å/second and 0.2 Å/second.

Then, a blue organic light-emitting layer (thickness: 30 nm) was formed on a desired blue light-emitting pixel on the hole-transport layer 32 by the method in which a material was applied to only a desired part by use of a shadow mask. The green organic light-emitting layer was formed in such a manner that 1,4-bis-triphenylsilyl-benzene (UGH-2) (host material) and bis[(4,6-difluorophenyl)-pyridinato-N,C2′]picolinate iridium (III) (FIrpic) (blue phosphorescent light-emitting dopant) were co-deposited at respective vapor-deposition speeds of 1.5 Å/second and 0.2 Å/second.

Next, a hole-blocking layer 34 (see FIG. 14) was formed on an organic light-emitting layer 33 (see FIG. 14) formed by the aforementioned method. The hole-blocking layer 34 had a film thickness of 10 nm and was made from 2,9-dimethyl-4,7-diphenyl-1,10-phenanthroline (BCP).

Then, an electron-transport layer 35 (film thickness: 30 nm), made from tris(8-hydroxyquinoline) aluminum (Alq₃), was formed on the hole-blocking layer 34.

Next, on the electron-transport layer 35, an electron-injection layer 36 (film thickness: 0.5 nm) was formed by use of LiF.

Then, aluminum (film thickness: 100 m) was provided by a vacuum vapor-deposition method. A second electrode 21 (see FIG. 13) was thus formed.

Next, SiON was provided by an ion plating method. Then, patterning was carried with the use of shadow mask so that only an edge part of the second electrode 21 was covered with SiON. An edge cover was thus formed on the edge part of the second electrode 21. In the present example, only a part extending from 4 sides of the second electrode 21 by 10 μm was covered with SiO₂ (not illustrated).

Then, LiF was provided by the vacuum vapor-deposition method so that an electron-injection layer 36′ (film thickness: 0.5 nm) was formed on the second electrode 21.

Next, the tris(8-hydroxyquinoline) aluminum (Alq₃) was provided on the electron-injection layer 36′ so as to form an electron-transport layer 35′ (film thickness: 30 nm) (see FIG. 13).

Then, 2,9-dimethyl-4,7-diphenyl-1,10-phenanthroline (BCP) was provided on the electron-transport layer 35′ so as to form a hole-blocking layer 34′ (film thickness: 10 nm) (see FIG. 13).

Then, by the method in which a material was applied to only a desired part by use of the shadow mask, an organic red light-emitting layer 33′ (thickness: 30 nm) was formed on a desired red light-emitting pixel on the hole-blocking layer 34′. The red organic light-emitting layer 33′ was formed in such a manner that 3-phenyl-4(1′-naphthyl)-5-phenyl-1,2,4-triazole (TAZ) (host material) and bis(2-(2′-benzo[4,5-a]thienyl)pyridinato-N,C3′) iridium (acetylacetonate) (btp₂Ir(acac)) (red phosphorescent light-emitting dopant) were co-deposited at respective vapor-deposition speeds of 1.4 Å/second and 0.15 Å/second.

Next, a green organic light-emitting layer 33′ (thickness: 30 nm) was formed on a desired green light-emitting pixel provided on the hole-blocking layer 34′ by the method in which a material was applied to a desired part by use of a shadow mask. The green organic light-emitting layer 33′ was formed in such a manner that TAZ (host material), and tris(2-phenylpyridine) iridium (III) (Ir(ppy)₃) (green phosphorescent light-emitting dopant) were co-deposited at respective vapor-deposition speeds of 1.5 Å/second and 0.2 Å/second.

Then, a blue organic light-emitting layer 33′ (thickness: 30 nm) was formed on a desired blue light-emitting pixel on the hole-blocking layer 34′ by the method in which a material was applied to only a desired part by use of a shadow mask. The green organic light-emitting layer 33′ was formed in such a manner that 1,4-bis-triphenylsilyl-benzene (UGH-2) (host material) and bis[(4,6-difluorophenyl)-pyridinato-N,C2′]picolinate iridium (III) (FIrpic) (blue phosphorescent light-emitting dopant) were co-deposited at respective vapor-deposition speeds of 1.5 Å/second and 0.2 Å/second.

Next, as a hole-transport material, N,N′-Di(1-naphthyl)-N,N′-diphenyl-1,1′-biphenyl-1,1′-biphenyl-4,4′-diamine (NPD) was provided on the organic light-emitting layer 33′ by the resistance heating vapor-deposition method, so that a hole-transport layer 32′ (film thickness: 40 nm) was formed (see FIG. 13).

After that, in a desired region, 1,1-bis-di-4-tolylamino-phenyl-cychrohexane (TAPC) was provided as a hole-injection material by the method in which a material was applied to only a desired part by use of a shadow mask. By a resistance heating vapor-deposition method, a hole-injection layer 31′ (see FIG. 13) was provided to have (i) a film thickness of 50 nm in a red light-emitting pixel section (ii) a thickness of 150 nm in a green light-emitting pixel section and (iii) a thickness of 100 nm in a blue light-emitting pixel section.

On the hole-injection layer 31′, indium tin oxide (ITO) was provided by the ion plating method by use of a shadow mask so that a transparent electrode (anode) (film thickness: 300 nm) was formed as a third electrode 22.

Next, on the third electrode 22, a protection layer, which had a film thickness of 100 nm and was made from SiON, was formed, by an ion plating method by use of a shadow mask, in an area extending from the 4 sides of the light-emitting section 11 by 2 mm. Further, on the protection layer, a parylene film having a film thickness of 2 μm was formed by a vapor-deposition polymerization method. The formation of the protection layer (SiON) and the parylene film was carried out 5 times so that a laminate film constituted by 5 layers was formed. The laminate film was used as a sealing section 12. The slat 2 illustrated in FIG. 14 was thus completed.

Finally, a plurality of slats 2 thus manufactured were arranged in parallel with each other by use of a support wire 4 (see FIG. 12), so as to constitute a blind. Further, a conductive wire group 3 was provided so as to supply an input signal received from a power supply device 7 (see FIG. 12) provided in a head box to the light-emitting section 11 (supply of a current or application of a voltage). A conductive wire group 3 for controlling light-emitting was connected to (i) terminals 15 and 17 provided one the slat 2 in the vicinity of respective short sides of the slat 2 and (ii) a terminal 14 provided on the slat 2 in the vicinity of one of long sides of the slat 2. A blind-type illumination device in which a slat 2 was used as 1 unit was thus completed.

Note that a curved shape of the slat 2 was realized by (i) using the substrate 10 which originally had a curved shape or (ii) causing the substrate 10 to be curved before each of the layers described above was formed.

Here, a desired voltage was applied from the power supply device to a group of electrodes of the illumination device thus completed. As a result, it was confirmed that desired uniform white light could be achieved without any problem.

### Example 4

### Illumination Device Having Arrangement of Embodiment 3

The present example deals with a specific arrangement described in Embodiment 3. The present example employs a top-emission structure in which (i) two substrates 10 were attached to each other, and (ii) light was taken out from two sealing sections 12, which serves as respective surfaces of a slat.

A substrate 10 used here was the same as that of Example 3. A first electrode (anode) of each pixel was formed on one of surfaces of the substrate 10 by a sputtering method. A first electrode 20 was formed in such a manner that Al (aluminum) (film thickness: 150 nm) and IZO (indium oxide-zinc oxide) (film thickness: 20 nm) were laminated with each other.

Next, on the surface (500×220 mm²), patterning was carried out only in a certain area (492×216 mm²) by a photolithography method so that the first electrode 20 was formed only in the certain area.

Next, SiO₂ (thickness: 200 nm) was provided by the sputtering method. Then, SiO₂ was patterned by the photolithography method so that only an edge part of the first electrode 20 was covered with SiO₂. An edge cover was thus formed on the edge part of the first electrode 20. In the present example, only a part extending from 4 sides of the first electrode 20 by 10 μm was covered with SiO₂ (not illustrated).

Then, processes were carried out in the same manner as Example 1, until before a process in which RGB light-emitting pixels were formed by a method in which a material was applied to only a desired part by use of a shadow mask.

Next, after the aforementioned processes were carried out, RGB light-emitting pixels were provided on the substrates 10 on each of which the first electrode was formed. The provision of the RGB light-emitting pixels was carried out by a vapor-deposition method in which a material was applied to only a desired part by use of a shadow mask.

After that, in a desired region, 1,1-bis-di-4-tolylamino-phenyl-cychrohexane (TAPC) was provided as a hole-injection material by the method in which a material was applied to only a desired part by use of a shadow mask. By a resistance heating vapor-deposition method, a hole-injection layer 31 (see FIG. 13) was provided to have (i) a film thickness of 50 nm in a red light-emitting pixel section (ii) a thickness of 150 nm in a green light-emitting pixel section and (iii) a thickness of 100 nm in a blue light-emitting pixel section.

Next, as a hole-transport material, N,N′-Di (1-naphthyl)-N,N′-diphenyl-1,1′-biphenyl-1,1′-biphenyl-4,4′-diamine (NPD) was provided by the resistance heating vapor-deposition method, so as to form a hole-transport layer 32 (film thickness: 40 nm) (see FIG. 13).

Then, by the method in which a material was applied to only a desired part by use of the shadow mask, an organic red light-emitting layer (thickness: 30 nm) was formed on a desired red light-emitting pixel on the hole-transport layer 32. The red organic light-emitting layer was formed in such a manner that 3-phenyl-4(1′-naphthyl)-5-phenyl-1,2,4-triazole (TAZ) (host material) and bis(2-(2′-benzo[4,5-a]thienyl)pyridinato-N,C3′) iridium (acetylacetonate) (btp₂Ir(acac)) (red phosphorescent light-emitting dopant) were co-deposited at respective vapor-deposition speeds of 1.4 Å/second and 0.15 Å/second.

Next, a green organic light-emitting layer (thickness: 30 nm) was formed on a desired green light-emitting pixel provided on the hole-transport layer 32 by the method in which a material was applied to a desired part by use of a shadow mask. The green organic light-emitting layer was formed in such a manner that TAZ (host material), and tris (2-phenylpyridine) iridium (III) (Ir(ppy)₃) (green phosphorescent light-emitting dopant) were co-deposited at respective vapor-deposition speeds of 1.5 Å/second and 0.2 Å/second.

Then, a blue organic light-emitting layer (thickness: 30 nm) was formed on a desired blue light-emitting pixel on the hole-transport layer 32 by the method in which a material was applied to only a desired part by use of a shadow mask. The green organic light-emitting layer was formed in such a manner that 1,4-bis-triphenylsilyl-benzene (UGH-2) (host material) and bis[(4,6-difluorophenyl)-pyridinato-N,C2′]picolinate iridium (III) (FIrpic) (blue phosphorescent light-emitting dopant) were co-deposited at respective vapor-deposition speeds of 1.5 Å/second and 0.2 Å/second.

Next, a hole-blocking layer 34 (see FIG. 13) was formed on an organic light-emitting layer 33 (see FIG. 13) formed by the aforementioned method. The hole-blocking layer 34 had a film thickness of 10 nm and was made from 2,9-dimethyl-4,7-diphenyl-1,10-phenanthroline (BCP).

Then, an electron-transport layer 35 (film thickness: nm), made from tris(8-hydroxyquinoline) aluminum (Alq₃), was formed on the hole-blocking layer 34.

Then, a magnesium-silver (1:9) alloy (film thickness: 19 nm) was formed on a surface of the electron-transport layer 35 by a vacuum vapor-deposition method. The translucent second electrode 21 (see FIG. 19) was thus formed.

Next, on the translucent second electrode 21, a protection layer, which had a film thickness of 100 nm and was made from SiON, was formed, by an ion plating method by use of a shadow mask, in an area extending from the 4 sides of the light-emitting section 11 by 2 mm. Further, on the protection layer, a parylene film having a film thickness of 2 μm was formed by a vapor-deposition polymerization method. The formation of the protection layer (SiON) and the parylene film was carried out 5 times so that a laminate film constituted by 5 layers was formed. The laminate film was used as each of the sealing sections 12.

Two structures each being constituted by the substrate, the light-emitting section, and the sealing section thus obtained were attached to each other. An epoxy resin was provided between the two substrates 10, so that the two substrates 10 were attached to each other. A slat 2′ illustrated in FIG. 19 was thus completed.

Finally, in the same manner as Example 3, (i) a plurality of slats 2′ thus manufactured were arranged in parallel with each other, (ii) a conductive wire group 3 was provided so as to supply an input signal received from a power supply device provided in a head box 7 to the light-emitting section 11 (supply of a current or application of a voltage), (iii) the conductive wire group 3 was connected to terminals 14, 15, and 17. A blind-type illumination device in which a slat 2′ was used as 1 unit was thus completed (not illustrated).

Note that a curved shape of the slat 2 was realized by (i) using the substrate 10 which originally had a curved shape, or (ii) causing the substrate 10 to be curved before each of the layers described above was formed.

Here, a desired voltage was applied from the power supply device to a group of electrodes of the illumination device thus completed. As a result, it was confirmed that desired uniform white light could be achieved without any problem.

The present invention is not limited to the description of the embodiments above, but may be altered by a skilled person within the scope of the claims. An embodiment based on a proper combination of technical means disclosed in different embodiments is encompassed in the technical scope of the present invention. The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### CONCLUSION OF THE PRESENT INVENTION

As described above, an illumination device of the present invention of the present invention includes: a plurality of slats each having flexibility, each of the plurality of slats having a light-emitting element which emits light by supply of a current to the light-emitting element or application of a voltage to the light-emitting element, the light-emitting element including a first electrode and a second electrode; a support section for supporting the plurality of slats so that the plurality of slats are movable rotatably forward and backward, the support section including (i) a plurality of first support members provided for the plurality of slats, respectively, each of the plurality of first support members extending across one of surfaces of a corresponding one of the plurality of slats, and (ii) a second support member which is connected to the plurality of first support members so that the plurality of slats are arranged in parallel with each other; and a plurality of structures provided for the plurality of slats, respectively, each of the plurality of structures (i) being provided in the vicinity of the one of surfaces of the corresponding one of the plurality of slats, and (ii) giving, in accordance with rotational movement of the corresponding one of the plurality of slats, caused by the support section, pressure to the corresponding one of the plurality of slats from a position in the vicinity of the one of surfaces toward the other one of surfaces.

According to the arrangement, the illumination device includes the plurality of structures each (i) being provided in the vicinity of the one of surfaces of the corresponding one of the plurality of slats, and (ii) giving, in accordance with rotational movement of the corresponding one of the plurality of slats, caused by the support section, pressure to the corresponding one of the plurality of slats from a position in the vicinity of the one of surfaces toward the other one of surfaces. The plurality of structures make it possible for the plurality of slats each having flexibility to be bent in accordance with the rotational movement. That is, it is possible to cause a shape of each of the plurality of slats to have a desired curvature radius reversibly.

As described above, by causing the slat to have a desired curvature radius reversibly, it becomes possible to cause the light emitted from the light-emitting element of the slat to be diffused or condensed. Accordingly, it is possible to provide an illumination device which can meet any lighting purposes.

Further, in addition to the arrangement described above, the illumination device of the present invention is preferably such that each of the plurality of structures is provided between the one of surfaces and the first support member.

According to the arrangement, the structure can effectively give pressure to the slat in accordance with the rotational movement of the first support member.

Furthermore, in addition to the arrangement described above, the illumination device of the present invention is preferably arranged such that each of the plurality of slats has a through-hole extending through the slat from the one of surfaces of the slat to the other one of surfaces of the slat, and the illumination device further comprises an up-and-down code for adjusting a length from, among the plurality of slats, a slat provided in an uppermost position, to a slat provided in a lowermost position, the up-and-down code being provided so as to extend through the through-hole of each of the plurality of slats.

According to the arrangement, in a case where the illumination device is not in use, the illumination device can be made compact in such a manner that (i) the plurality of slats are caused to be closer to each other by use of the up-and-down code and as a result (ii) the length from the slat in the uppermost position to the slat in the lowermost position is caused to be short. Further, in a case where the illumination device is used, the illumination device can be set by use of the up-and-down code so as to emit light.

Moreover, in addition to the arrangement described above, the illumination device of the present invention can be arranged such that, in each of the plurality of slats, the organic electroluminescence element is positioned to emit light from the other one of surfaces.

However, the present invention is not limited to the arrangement. The illumination device of the present invention can be arranged such that, in each of the plurality of slats, the organic electroluminescence element is positioned to emit light from the one of surfaces.

Further, in addition to the arrangement, the illumination device of the present invention is preferably arranged such that the light-emitting element is such an organic electroluminescence element that an organic layer including an organic light-emitting layer is provided between the first electrode and the second electrode.

By employing the organic electroluminescence element, it is possible to realize a thin light-emitting slat. It becomes therefore possible to provide a blind-type illumination device which can be suitably used.

Furthermore, in addition to the arrangement, the illumination device of the present invention preferably further includes: a first conductive wire being connected to the first electrode of each of the plurality of slats; a second conductive wire being connected to the second electrode of each of the plurality of slats; and a power supply device being connected to both the first conductive wire and the second conductive wire.

According to the arrangement, the power supply device is connected to the first electrode and the second electrode which constitute the light-emitting element of each of the plurality of slats. Accordingly, it is possible to supply a current to the slat stably or apply a voltage to the slat stably. For this reason, it is possible to provide an illumination device which can stably emit light irrespective of an intensity of external light (particularly, the weather) and therefore has high credibility, as compared with an arrangement in which no power supply device is provided, and light is emitted from the light-emitting element by use of sunlight.

Moreover, in addition to the arrangement, the illumination device of the present invention is preferably arranged such that each of the plurality of slats is arranged such that the light emitted from the light-emitting element is emitted from both (i) the one of surfaces of the slat and (ii) the other one of surfaces of the slat.

According to the arrangement, each of the plurality of slats is arranged such that the light emitted from the light-emitting element is emitted from both (i) the one of surfaces of the slat and (ii) the other one of surfaces of the slat. In a case where the slat emits light only from one of surfaces of the slat, and a user hopes to carry out switching between a mode for condensing light and a mode for diffusing light, it is necessary to replace the slat itself with another slat. On the other hand, according to the arrangement described above, it is possible to carry out, without replacing the slat with another slat, switching between the mode for condensing light and the mode for diffusing light by rotational movement of the slat by use of the support section, if necessary.

Further, in addition to the arrangement, the illumination device of the present invention is preferably arranged such that the light-emitting element is such an organic electroluminescence element that a first electrode, a first organic layer including a first organic light-emitting layer, a second electrode, a second organic layer including a second organic light-emitting layer, and a third electrode are provided in this order on a substrate made from a transparent material or a translucent material, and the first electrode and the third electrode are made from a transparent material or a translucent material.

According to the arrangement, it is possible to provide a slat which emits light from both surfaces of the slat by use of the light-emitting of the first organic layer including the first organic light-emitting layer and the light-emitting of the second organic layer including the second organic light-emitting layer.

Furthermore, in addition to the arrangement, the illumination device of the present invention preferably further includes: a first conductive wire being connected to the first electrode of each of the plurality of slats; a second conductive wire being connected to the second electrode of each of the plurality of slats so as to cause the first organic light-emitting layer of each of the plurality of slats to emit light; a third conductive wire being connected to the second electrode of each of the plurality of slats so as to cause the second organic light-emitting layer of each of the plurality of slats to emit light; a fourth conductive wire being connected to the third electrode of each of the plurality of slats; and a power supply device being connected to the first conductive wire, the second conductive wire, the third conductive wire, and the fourth conductive wire.

According to the arrangement, the power supply device is connected to the electrodes constituting the light-emitting element of each of the plurality of slats. Accordingly, it is possible to supply a current to the slat stably or apply a voltage to the slat stably. For this reason, it is possible to provide an illumination device which can emit light stably irrespective of an intensity of external light (particularly, the weather) and therefore has high credibility, as compared with an arrangement in which no power supply device is provided and a light-emitting element emits light by use of sunlight.

Moreover, in addition to the arrangement, the illumination device of the present invention can be arranged such that each of the plurality of slats is arranged such that (i) a structure in which the light-emitting element is provided on a substrate serves as 1 unit, and (ii) at least 2 units overlap each other.

With the arrangement, it is possible to carry out such a process that (i) a single light-emitting element constituted by a plurality of layers is provided on a substrate, and then (ii) substrates on each of which the light-emitting element has been provided are stacked with each other. In this case, it is possible to manufacture the slat efficiently in a short production period, as compared with a case where plurality of light-emitting elements each being constituted by a plurality of layers are provided continuously.

Further, in addition to the arrangement, the illumination device of the present invention is preferably arranged such that the light-emitting element includes two organic electroluminescence elements each being such that first electrode, an organic layer including an organic light-emitting layer, and a second electrode made from a transparent material or a translucent material are provided in this order on a substrate, the two organic electroluminescence elements are provided on a front surface and a back surface of the substrate, respectively, and the substrate is constituted by a layer on a front surface side and another layer on a back surface side.

According to the arrangement, it is possible to provide a slat which emits light from both surfaces of the slat by use of (i) the light-emitting of the first organic layer including the first organic light-emitting layer, provided on the front surface side of the substrate, and (ii) the light-emitting of another first organic layer including another first organic light-emitting layer, provided on the back surface side of the substrate.

Furthermore, in addition to the arrangement, the illumination device of the present invention preferably further includes: a first conductive wire being connected to the first electrode provided on the front surface side of the substrate of each of the plurality of slats; a second conductive wire being connected to the second electrode provided on the front surface side of the substrate of each of the plurality of slats; a third conductive wire being connected to another first electrode provided on the back surface side of the substrate of each of the plurality of slats; a forth conductive wire being connected to another second electrode provided on the back surface side of the substrate of each of the plurality of slats; and a power supply device being connected to the first conductive wire, the second conductive wire, the third conductive wire, and the fourth conductive wire.

According to the arrangement, the power supply device is connected to the first electrode and the second electrode constituting the light-emitting element of each of the plurality of slats. Accordingly, it is possible to supply a current to the slat stably or apply a voltage to the slat stably. For this reason, it is possible to provide an illumination device which can emit light stably irrespective of an intensity of external light (particularly, the weather) and therefore has high credibility, as compared with an arrangement in which no power supply device is provided and a light-emitting element emits light by use of sunlight.

Moreover, in addition to the arrangement, the illumination device of the present invention is preferably arranged such that the substrate of each of the plurality of slats has a rectangular shape, a terminal connected to the first conductive wire or a terminal connected to the second conductive wire is provided along one of short sides of the rectangular shape, while a terminal connected to the third conductive wire or a terminal connected to the fourth conductive wire is provided along the other one of short sides of the rectangular shape, the first conductive wire and the second conductive wire are provided in the vicinity of the one of short sides of the rectangular shape, and the third conductive wire and the fourth conductive wire are provided in the vicinity of the other one of short sides of the rectangular shape.

According to the arrangement, a terminal is provided along one of short sides of the rectangular shape, and a conductive wire connected to the terminal is provided in the vicinity of the terminal. Further, another terminal is provided along the other one of short sides of the rectangular shape, and another conductive wire connected to the another terminal is provided in the vicinity of the another terminal. Here, if all the conductive wires are provided in the vicinity of one of short sides of the rectangular shape, it is necessary to one of the conductive wires to be extended to be connected to the terminal provided along the other one of short sides of the rectangular shape. This causes an increase in a resistance of the conductive wire. On the other hand, according to the arrangement described above, the conductive wires are provided in the vicinity of the respective terminals to be connected to the conductive wires. It is therefore possible to prevent an increase in a resistance of the conductive wire.

Further, according to the arrangement described above, as compared with the arrangement in which all the conductive wires are provided in the vicinity of one of short sides of the rectangular shape, it is possible to arrange the conductive wires to be away from each other, that is, part of the conductive wires are provided in the vicinity of the one of short sides, and the other part of the conductive wires are provided in the vicinity of the other one of short sides. In a case of the arrangement in which all the conductive wires are provided in the vicinity of one of short sides of the rectangular shape, there is a risk that the conductive wires might be in contact with each other. For this reason, there is a case where it is necessary to carry out a process for coating the conductive wires with an insulating material. However, according to the arrangement described above, it is not necessary to carry out such a process. It is therefore possible to prevent an increase in cost.

### INDUSTRIAL APPLICABILITY

The present invention is applicable to an illumination device, and has high industrial applicability.

### REFERENCE SIGNS LIST

1: Illumination device
2: Slat
3: Conductive wire group (first conductive wire, second conductive wire, third conductive wire, fourth conductive wire)
3a: First conductive wire group (first conductive wire, second conductive wire)
3b, 3b′: Second conductive wire group (third conductive wire, fourth conductive wire)
4: Support wire (support section)
4a: First support wire (first support member)
4b: Second support wire (second support member)
5: Slat pressure member (structure)
6: Up-and-down code
7: Power supply device
10: Substrate
11, 11′: Light-emitting section (light-emitting element)
12: Sealing section
14: Terminal of second electrode
15: Terminal of first electrode
17: Terminal of third electrode
20: First electrode
21: Second electrode
22: Third electrode
27: Through-hole
28: Edge cover
30: Organic layer
30a: First organic layer
30b: Second organic layer
31, 31′: Hole-injection layer
32, 32′: Hole-transport layer
33, 33′: Organic light-emitting layer
34, 34′: Hole-blocking layer
35, 35′: Electron-transport layer
36, 36′: Electron-injection layer
40: Switching TFT
41: Driving TFT

1. An illumination device comprising:
a plurality of slats each having flexibility, each of the plurality of slats having a light-emitting element which emits light by supply of a current to the light-emitting element or application of a voltage to the light-emitting element, the light-emitting element including a first electrode and a second electrode;
a support section for supporting the plurality of slats so that the plurality of slats are movable rotatably forward and backward, the support section including (i) a plurality of first support members provided for the plurality of slats, respectively, each of the plurality of first support members extending across one of surfaces of a corresponding one of the plurality of slats, and (ii) a second support member which is connected to the plurality of first support members so that the plurality of slats are arranged in parallel with each other; and
a plurality of structures provided for the plurality of slats, respectively, each of the plurality of structures (i) being provided in the vicinity of the one of surfaces of the corresponding one of the plurality of slats, and (ii) giving, in accordance with rotational movement of the corresponding one of the plurality of slats, caused by the support section, pressure to the corresponding one of the plurality of slats from a position in the vicinity of the one of surfaces toward the other one of surfaces.

2. The illumination device as set forth in claim 1, wherein:
each of the plurality of structures is provided between the one of surfaces and the first support member.

3. The illumination device as set forth in claim 1, wherein:
each of the plurality of slats has a through-hole extending through the slat from the one of surfaces of the slat to the other one of surfaces of the slat; and
the illumination device further comprises an up-and-down code for adjusting a length from, among the plurality of slats, a slat provided in an uppermost position, to a slat provided in a lowermost position, the up-and-down code being provided so as to extend through the through-hole of each of the plurality of slats.

4. The illumination device as set forth in claim 1, wherein:
in each of the plurality of slats, the light-emitting element is positioned to emit light from the other one of surfaces.

5. The illumination device as set forth in claim 1, wherein:
in each of the plurality of slats, the light-emitting element is positioned to emit light from the one of surfaces.

6. The illumination device as set forth in claim 1, wherein:
the light-emitting element is such an organic electroluminescence element that an organic layer including an organic light-emitting layer is provided between the first electrode and the second electrode.

7. The illumination device as set forth in claim 1, further comprising:
a first conductive wire being connected to the first electrode of each of the plurality of slats;
a second conductive wire being connected to the second electrode of each of the plurality of slats; and
a power supply device being connected to both the first conductive wire and the second conductive wire.

8. The illumination device as set forth in claim 1, wherein:
each of the plurality of slats is arranged such that the light emitted from the light-emitting element is emitted from both (i) the one of surfaces of the slat and (ii) the other one of surfaces of the slat.

9. The illumination device as set forth in claim 8, wherein:
the light-emitting element is such an organic electroluminescence element that a first electrode, a first organic layer including a first organic light-emitting layer, a second electrode, a second organic layer including a second organic light-emitting layer, and a third electrode are provided in this order on a substrate made from a transparent material or a translucent material; and
the first electrode and the third electrode are made from a transparent material or a translucent material.

10. The illumination device as set forth in claim 9, further comprising:
a first conductive wire being connected to the first electrode of each of the plurality of slats;
a second conductive wire being connected to the second electrode of each of the plurality of slats so as to cause the first organic light-emitting layer of each of the plurality of slats to emit light;
a third conductive wire being connected to the second electrode of each of the plurality of slats so as to cause the second organic light-emitting layer of each of the plurality of slats to emit light;
a fourth conductive wire being connected to the third electrode of each of the plurality of slats; and
a power supply device being connected to the first conductive wire, the second conductive wire, the third conductive wire, and the fourth conductive wire.

11. The illumination device as set forth in claim 8, wherein:
each of the plurality of slats is arranged such that (i) a structure in which the light-emitting element is provided on a substrate serves as 1 unit, and (ii) at least 2 units overlap each other.

12. The illumination device as set forth in claim 8, wherein:
the light-emitting element includes two organic electroluminescence elements each being such that first electrode, an organic layer including an organic light-emitting layer, and a second electrode made from a transparent material or a translucent material are provided in this order on a substrate;
the two organic electroluminescence elements are provided on a front surface and a back surface of the substrate, respectively; and
the substrate is constituted by a layer on a front surface side and another layer on a back surface side.

13. The illumination device as set forth in claim 12, further comprising:
a first conductive wire being connected to the first electrode provided on the front surface side of the substrate of each of the plurality of slats;
a second conductive wire being connected to the second electrode provided on the front surface side of the substrate of each of the plurality of slats;
a third conductive wire being connected to another first electrode provided on the back surface side of the substrate of each of the plurality of slats;
a forth conductive wire being connected to another second electrode provided on the back surface side of the substrate of each of the plurality of slats; and
a power supply device being connected to the first conductive wire, the second conductive wire, the third conductive wire, and the fourth conductive wire.

14. The illumination device as set forth in claim 10, wherein:
the substrate of each of the plurality of slats has a rectangular shape;
a terminal connected to the first conductive wire or a terminal connected to the second conductive wire is provided along one of short sides of the rectangular shape, while a terminal connected to the third conductive wire or a terminal connected to the fourth conductive wire is provided along the other one of short sides of the rectangular shape;
the first conductive wire and the second conductive wire are provided in the vicinity of the one of short sides of the rectangular shape; and
the third conductive wire and the fourth conductive wire are provided in the vicinity of the other one of short sides of the rectangular shape.
